(19) United States
(12) Patent Application Publication
(10) Pub. No.: US 2025/0186980 A1
(43) Pub. Date: Jun. 12, 2025

(54) IN-SITU PROTON FILTER CATALYSTS FOR ELECTROCHEMICAL AMMONIA PRODUCTION

(71) Applicant: Khalifa University of Science and Technology, Abu Dhabi (AE)

(72) Inventors: Dinesh SHETTY, Abu Dhabi (AE); Ranjeesh Kayarmkodath CHANDRAN, Abu Dhabi (AE); Abdul Khayum MOHAMMED, Abu Dhabi (AE)

(21) Appl. No.: 18/535,607

(22) Filed: Dec. 11, 2023

(51) Int. Cl. B01J 31/06; B01J 23/46; C01C 1/04

(52) U.S. Cl. CPC B01J 31/06; B01J 23/462; C01C 1/0411

(57) ABSTRACT

An in-situ proton filter catalyst for ammonia production includes a covalent organic framework (COF) having a triazine and pyridine moiety, and a metal embedded into the COF. The porous COF includes two dimensional (2D) layers. During formation of the catalyst, the metal can partially delaminate the 2D layers and the metal precursor is reduced and can form nanoclusters. The metal nanoclusters are located between the 2D layers and in pores of the 2D layers. In some examples, the metal can be ruthenium. A concentration of the metal in the in-situ proton filter catalyst can be between about 1 and about 5 ppm, in some examples. A ratio (by weight) of the metal precursor to COF can be about 3:1, in some examples. The in-situ proton filter catalyst can be synthesized under ambient conditions and is thermally stable up to about 400° C. Moreover, the in-situ proton filter catalyst exhibits a high NH₃ yield rate and high F.E.

### BACKGROUND

Ammonia (NH₃) is the most promising carbon-free alternative energy carrier to hydrogen (H₂) in the evolving field of renewable energy due to its high weight fraction of hydrogen, case of liquefaction, and low transportation cost. However, NH₃ production under ambient conditions suffers from a low conversion yield and poor Faradaic efficiency (F.E.) because of strong competition from hydrogen evolution reaction (HER) and the poor solubility of N₂ in aqueous systems.

Commercially, NH₃ is produced by a well-established energy-intensive Haber-Bosch process because of the high triple bond energy (940.95 KJ mol⁻¹) and the net-zero dipole moment of the N₂ molecule. However, the critical challenges of this process are a low conversion efficiency (˜15%), the requirements of high pressure (20-40 MPa) and temperature (400-600° C.), and reliance on fossil fuels, which is responsible for 400 million tons of CO₂ emission per year. Moreover, the process requires the production of reactant H₂ via steam methane reforming, which consumes about 1.5% of the total world's electric energy. To address these issues, more scientific attention has been focused towards electrochemical N₂ reduction as a potential greener and sustainable alternative due to the utilization of water as the proton source and ambient working conditions. However, the low solubility of N₂ in aqueous media and serious competition from the less energy-intensive hydrogen evolution reaction (HER, especially in acidic media) results in unsatisfactory performance towards nitrogen reduction reaction (NRR), which is far from practical standards. For example, US Department of Energy (DOE) targets for optimal ammonia production, an efficient NRR electrocatalyst should show 50% faradaic efficiency (F.E.) and an NH₃ yield rate of over 1700 μg h⁻¹ cm⁻².

To improve the NRR performance of a catalyst, it is crucial to deal with the competitive HER. Hence, the rational design of an electrocatalyst with precise regulation of N₂ mass transport to achieve high local N₂ concentration near the electrode surface, which can effectively influence the selectivity of NRR over HER, is highly desirable. Ideally such catalyst can be accomplished by constructing a system where protons are either filtered before reaching the catalytic sites or should have a lower diffusion kinetics or higher energy barrier over N₂. This is highly challenging given the comparatively smaller size of protons. One of the successful strategies reported very recently utilizes the coating of proton-filtering porous material on the surface of the catalyst, which could lower the free energy barrier of N₂ diffusion and induce the starvation of protons at the catalytic active sites. However, it needs two independent systems to achieve the proton filtration and catalytic conversion, resulting in complicated electrode fabrication and catalytic inconsistency.

It would be beneficial to develop a single system with an in-situ proton filtration and catalytic center with reduced structural complexity of the electrodes and increased overall efficacy.

### SUMMARY

According to one aspect, a catalyst for ammonia production includes a Tta-Dfp covalent organic framework (COF) or analog thereof and a metal embedded into the Tta-Dfp COF to form the catalyst. The Tta-Dfp COF is formed from a 4,4′,4″-(1,3,5-Triazine-2,4,6-triyl)trianiline (Tta) monomer or analog thereof and a 2,6-diformylpyridine (Dfp) monomer or analog thereof.

According to another aspect, an in-situ proton filter catalyst for ammonia production includes a COF having a triazine and pyridine moiety and a metal embedded into the COF to form the catalyst. The COF includes two dimensional layers and the metal is located between the layers.

According to another aspect, a method of forming a catalyst for ammonia production includes synthesizing or providing a COF having a triazine and pyridine moiety. The COF moiety includes a plurality of two dimensional layers. The method further includes partially delaminating the plurality of layers by combining the COF moiety with a metal in a solution, and intercalating the metal between layers of the COF moiety to form the catalyst.

This summary is intended to provide an overview of subject matter of the present disclosure. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. The drawings illustrate generally, by way of example, but not by way of limitation, various embodiments discussed herein.

FIG. 1 is a schematic of synthesis of a Ru-Tta-Dfp COF for use as an in-situ proton filter catalyst.

FIG. 2 is a flowchart illustrating a process for forming the in-situ proton filter catalyst.

FIG. 3 is a schematic illustrating formation of the in-situ proton filter catalyst.

FIG. 4 is a PXRD profile for Tta-Dfp COFs with iron (Fe) and chromium (Cr).

FIG. 5A is a schematic of a Tta monomer.

FIGS. 5B-5D are schematics of analogs of the Tta monomer of FIG. 5A.

FIG. 6A is a schematic of a Dfp monomer.

FIGS. 6B and 6C are schematics of analogs of the Dfp monomer of FIG. 6A.

FIG. 7 is a schematic of the synthesis of a Tta-Dfp COF.

FIG. 8 is a schematic of the synthesis of a hydrazone linked Tta-Dfp analog framework.

FIG. 9 is a schematic of the synthesis of a Tta-Dfp analog framework using an alternative synthesis method.

FIG. 10 is a schematic of another synthesis method of a Tta-Dfp analog framework.

FIG. 11 is a schematic of yet another synthesis method of a Tta-Dfp analog framework.

FIG. 12A is an HRTEM image of an Ru-Tta-Dfp catalyst before NRR.

FIG. 12B is an HRTEM image of the Ru-Tta-Dfp catalyst of FIG. 12A after NRR.

FIG. 12C is an SAED pattern of the Ru nanocluster of the Ru-Tta Dfp catalyst.

FIG. 13A is a PXRD pattern of Ru-Tta-Dfp COF catalyst and Tta-Dfp COF.

FIG. 13B is a top view schematic of the layered Tta-Dfp COF.

FIG. 14A is an FT-IR spectra of Tta-Dfp COF and the Tta and Dfp monomers.

FIG. 14B is an FT-IR spectra comparing Ru-Tta-Dfp COF and Tta-Dfp COF.

FIG. 15A is a PC CPMAS NMR of Tta-Dfp COF and the Tta and Dfp monomers.

FIG. 15B is a BC CPMAS NMR comparing Ru-Tta-Dfp COF and Tta-Dfp COF.

FIG. 15C is a schematic of a structural building unit of Tta-Dfp COF.

FIG. 16 is a plot of UV-Visible absorption spectra of Tta-Dfp COF and Ru-Tta-Dfp COF,

FIG. 17 is a thermogravimetric curve of Tta-Dfp COF and Ru-Tta-Dfp COF.

FIG. 18 is a plot of BET N₂ adsorption/desorption isotherms of Tta-Dfp COF and Ru-Tta-Dfp COF.

FIG. 19A is a SEM image of Ru-Tta-Dfp COF.

FIG. 19B is an EDS dot mapping image for elemental distribution in Ru-Tta-Dfp COF.

FIG. 19C is a TEM image of Ru-Tta-Dfp COF.

FIG. 19D is an HR-TEM image of Ru-Tta-Dfp COF (inset SAED).

FIGS. 20A and 20B are plots of deconvoluted XPS spectra of Ru-Tta-Dfp COF and Tta-Dfp COF.

FIG. 21A is a linear sweep voltametric curve for Ru-Tta-Dfp COF.

FIG. 21B is a chronoamperometric curve for Ru-Tta-Dfp COF at various potentials.

FIG. 21C is a plot of UV-Vis spectra for NH₃ quantification.

FIG. 21D is a bar graph illustrating NH₃ yield rate and FE obtained after NRR for Ru-Tta-Dfp COF at various applied potentials.

FIG. 21E is a bar diagram illustrating the comparison of ¹⁴NH₄⁺ yield rates obtained by various methods for Ru-Tta-Dfp COF.

FIG. 21F is ¹H-NMR spectra showing absence and presence of NH₄⁺ in the electrolyte samples.

FIG. 22A is a linear sweep voltametric curve for Tta-Dfp COF.

FIG. 22B is a chronoamperometric curve for Tta-Dfp COF at various potentials.

FIG. 22C is a plot of UV-Vis spectra for NH₃ quantification.

FIG. 22D is a bar graph illustrating NH₃ yield rate and FE obtained after NRR for Tta-Dfp COF at various applied potentials.

FIG. 23A is a bar graph comparing yield rates after NRR by Ru-Tta-Dfp COF via various methods.

FIG. 23B is a bar graph showing yield rate and F.E. after switching gas-feed chronoamperometric experiment vs. RHE.

FIGS. 23C and 23D show deconvoluted XPS spectra of Ru-Tta-Dfp COF.

FIGS. 24A and 24B are snapshots of diffusion through the Tta-Dfp COF layers.

FIGS. 24C and 24D are plots of calculated mean-square-displacement (MSD), potential energy and variation of protons (FIG. 24C) and nitrogen (FIG. 24D) as a function of time.

FIG. 25 is a schematic of the synthesis of Tab-Dfp.

FIG. 26 is a schematic of the synthesis of Tab-Bda.

FIG. 27A shows linear sweep voltametrie curves for Ru Tta-Dfp compared to Tab-Bda, Ru-Tab-Bda, Tab-Dfp and Ru-Tap-Dfp.

FIG. 27B shows chronoamperometric curves for the samples of FIG. 27A.

FIG. 27C is a plot of UV-Vis spectra for the samples of FIG. 27A.

FIG. 27D is a bar graph illustrating yield rate and F.E. for the samples of FIG. 27A.

FIG. 28 is a mass spectrum after ¹⁵N₂ isotope labelling experiment by Ru-Tta-Dfp at −0.15 V.

FIGS. 29A and 29B are deconvoluted XPS spectra of N Is (FIG. 29A) and O 1s (FIG. 29B) before and after electrolysis.

### DETAILED DESCRIPTION

The present disclosure is directed to a single catalyst for in-situ proton filtration and nitrogen conversion in acidic media using a metal, such as Ruthenium (Ru), embedded in a nitrogen rich two-dimensional covalent organic framework (COF). Metalized COFs can be used for various applications, including electrocatalysis, particularly N₂ reduction catalysis and CO₂ reduction catalysis. In some embodiments, the organic framework is a triazine and pyridine moiety that undergoes metalation such that there are inherent metal sites where the framework controls reactant diffusion by suppressing proton supply and enhancing N₂ flux, causing highly selective and efficient catalysis. The single system catalyst disclosed herein with an in-situ proton filtration and nitrogen conversion active center at the catalyst-electrolyte interface can minimize electrode structural complexity and enhance catalytic performance. The present disclosure is directed to engineering high-performance NRR electrocatalysts for more feasible green NH₃ production. As provided herein, the electrocatalysts disclosed herein have thermal stability and reusability, and are highly scalable under ambient conditions.

The present disclosure is directed to a single catalyst that includes a COF, such as a COF having a triazine and pyridine moiety, with a metal embedded into the COF to form the catalyst. The present disclosure is directed to methods of forming the single catalyst for ammonia production and methods of using the single catalyst to perform in-situ proton filtration and nitrogen conversion.

The catalyst design disclosed herein utilizes the inherent tunable nature of the COF to introduce the proton filtering building blocks within its backbone and a metal coordination environment to incorporate active Ru metal centers. The choice of Ru metal is based on its suitable nitrogen adsorption energy and lower overpotential compared to other noble metals (Pt and Pd) for NRR. The precise integration of nitrogen atoms throughout the covalently-bonded skeleton, using nitrogen-rich organic molecules, provides several advantages: the basic nature of the nitrogen not only provides the sites for effective interaction with metal but also with protons produced within the reaction media, leading to less proton diffusion towards catalytically-active Ru sites. The strong van der Waals interactions between COFs and N₂ would accelerate the mass transport and increase the local N₂ concentration near the electrode surface, while the nucleophilic centers of COFs drive electrostatic interactions with the protons, which could prevent the majority of active protons and thus suppress HER. Besides, the diffusion of a few protons as a consequence of their small size might assist the subsequent hydrogenation of adsorbed N₂ molecules to produce NH₃ as a final value-added product. Furthermore, the x-conjugated electronic structure of Tta-Dfp offers smooth local electron transfer for effective NRR.

The catalyst design disclosed herein resulted in a highly efficient catalyst for aqueous NH₃ production (F.E. ˜52.9% and a yield rate of 2.03 mg h⁻¹ mg_{cat}⁻¹ in 0.1 M H₂SO₄), which surpasses the performance of state-of-the-art NRR catalysts and has achieved the US DOE target for ammonia production. The in-situ proton filtration and favored N₂ diffusion in Tta-Dfp are further confirmed by molecular dynamics simulation studies and density functional theory (DFT) calculations.

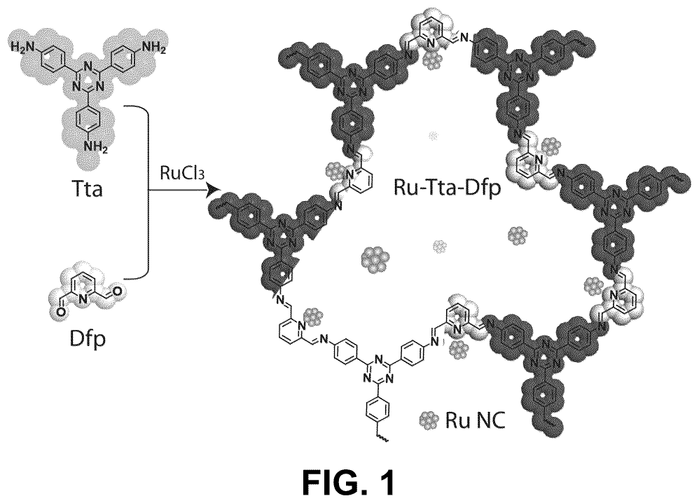

FIG. 1 is a schematic of an in-situ proton filter catalyst 100 for ammonia production. The catalyst 100 comprises a covalent organic framework (COF) having a triazine and pyridine moiety, and a metal embedded into the COF to form the catalyst. In the example shown in FIG. 1. the catalyst 100 is Ru-Tta-Dfp, and the catalyst 100 is formed from a 4,4′,4″-(1,3,5-Triazine-2,4,6-triyl)trianiline (Tta) monomer 102 and a 2,6-diformylpyridine (Dfp) monomer 104. As detailed further below, a Tta-Dfp COF can first be formed or obtained. Next, the Tta-Dfp COF can undergo metalation to form the catalyst 100. In the example shown in FIG. 1, the metal is Ruthenium (Ru). The metal is present as nanoclusters 106 that embed or integrate into the COF during metalation. As provided below, Ruthenium is a preferred metal for use in the catalyst 100. However, the catalyst 100 is not limited to Ruthenium and other alternative metals are included below.

The Ru-Tta-Dfp COF catalyst 100 or Ru-Tta Dfp catalyst 100 can also be referred to as an in-situ proton filtering NRR catalyst or in-situ proton filter catalyst. Alternative structures to the Tta-Dfp COF that function similarly to the Tta-Dfp COF can also be used in the catalyst 100. Thus, the COF can be referred to herein as a Tta-Dfp COF or analog thereof, or as a COF consisting of a moiety of triazine and pyridine. Alternative structures to the Tta monomer can also be used in forming the Tta-Dfp COF that function similarly to the Tta monomer, and thus collectively can be referred to herein as a Tta monomer or analog thereof. Similarly, alternative structures to the Dfp monomer can also be used in forming the Tta-Dfp COF that function similarly to the Dfp monomer, and thus collectively can be referred to herein as a Dfp monomer or analog thereof.

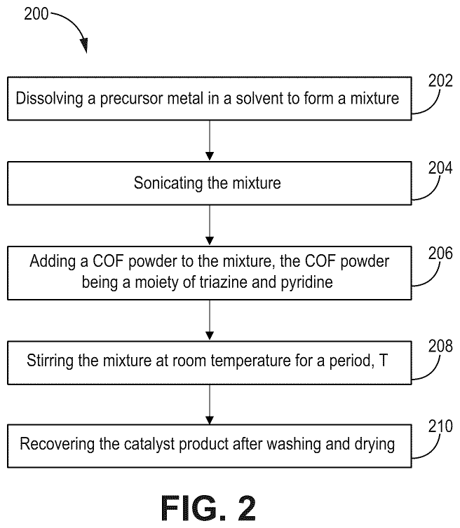

FIG. 2 illustrates a process 200 for forming an in-situ proton filter catalyst for ammonia product. The process 200 includes at step 202 dissolving a precursor metal in a solvent to form a mixture. In an example, the precursor metal is ruthenium and the solvent is methanol.

In one example, the ruthenium is added to the solvent as ruthenium (III) chloride (RuCl₃·xH₂O). In some embodiments. 60 mg of ruthenium chloride is added to 10 ml of methanol.

Next, under step 204, the mixture is sonicated. In one example, the mixture is sonicated for about 10 minutes. Under step 206, a COF powder is added to the mixture. The COF powder can be a triazine and pyridine moiety. In one example, the COF powder is Tta-Dfp formed from a 4,4′,4″-(1,3,5-Triazine-2,4,6-triyl)trianiline (Tta) monomer and a 2,6-diformylpyridine (Dfp) monomer. An example process for synthesizing a Tta-Dfp COF is provided below in Example 1 under the Examples section. In some embodiments, 20 mg of the COF powder is added to the metal-methanol mixture of steps 202 and 204.

In step 208, the mixture, which now includes the Tta-Dfp COF, is stirred at room temperature for a period, T. In one example, the period T can be about 48 hours. In other examples, the period T can be more or less time. A benefit of the catalyst and methods disclosed herein is that the COF can undergo metalation at room temperature. In step 210, the product (i.e. the catalyst) can be recovered from the mixture. Step 210 can include centrifugation, multiple washings (for example, using methanol) and drying under vacuum. In one example, drying is done at about 60° C.

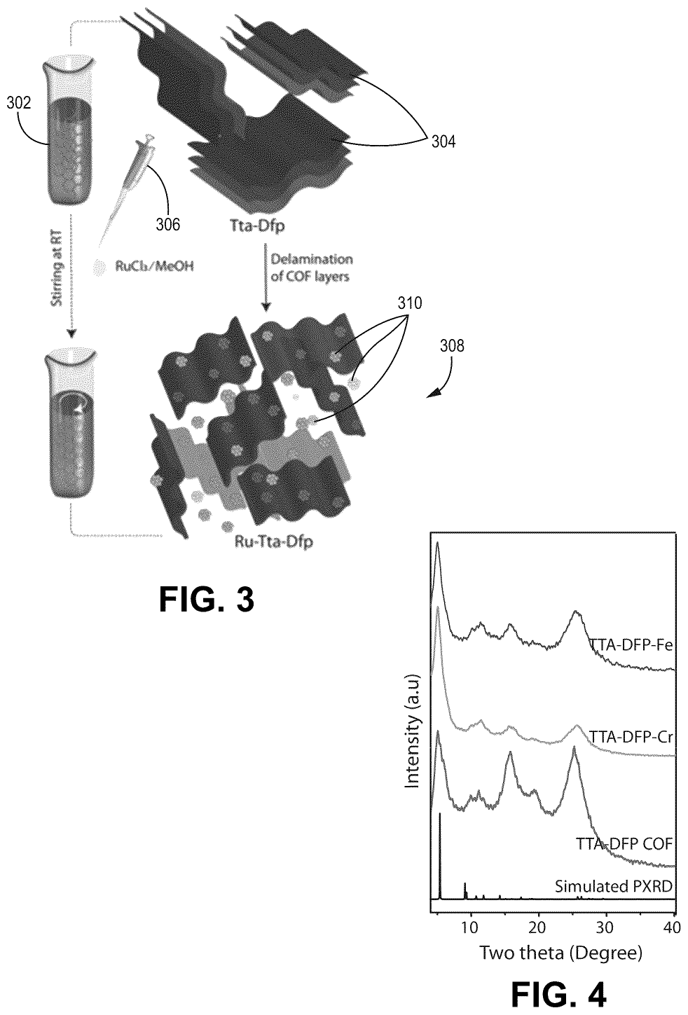

FIG. 3 is a schematic illustrating structural changes to the COF during metalation. As described above in reference to the process 200, a mixture 302 can be formed by combining a Tta-Dfp COF 304 with metal, RuCl₃ (represented by 306). The Tta-Dfp COF 304 can be made up of a plurality of two-dimensional (2D) stacked layers. After the metal 306 and the Tta-Dfp COF 304 are combined and then stirred at room temperature (RT), ruthenium acts to delaminate the COF layers such that the resulting structure (a Ru-Tta-Dfp COF catalyst 308) is at least partially delaminated. At the same time, the Tta-Dfp COF 304 can act as a reducing agent for the reduction of RuChs into Ru (0) nanoclusters 310. The nanoclusters 310 can be located between the partially delaminated 2D layers of the COF 304 and in pores of the porous COF 304 such that the nanoclusters 310 are embedded or integrated into the COF 304. In some embodiments, the size of the nanoclusters 310 is between about 3 and about 10 Å. In other embodiments, the nanocluster size is between about 4.5 and about 9 Å. In some embodiments, a pore size of the 2D layers ranges between about 0.5 nm and about 2 nm. In other embodiments, the pore size ranges between about 0.7 and about 1.7 nm.

In some embodiments, a d-spacing of the nanoclusters 310 is between about 0.1 and about 0.9 nm. In other embodiments, the d-spacing of the nanoclusters 310 is between about 0.2 and about 0.8 nm, or between about 0.2 and about 0.5 nm. In some embodiments, the d-spacing is about 0.2 nm. The d-spacing for the nanocluster can also be referred to as interplanar spacing (i.e. the spacing between two consecutive planes of the nanocluster).

The amount of metal in the catalyst can vary relative to an amount of COF in the catalyst. In the example above, 60 mg of Ruthenium chloride (metal precursor) was added to the methanol solution and 20 mg of COF was added to the mixture of Ruthenium chloride and methanol. In other embodiments, more or less Ruthenium chloride can be used. Table 1 below shows exemplary ratios of Ru precursor to COF.

TABLE 1
Loading Amounts of Ruthenium in Tta-Dfp COF

| | Amount of | | Amount of | |
|---|---|---|---|---|
| | Ruthenium | Amount of | Methanol | |
| | (III) chloride | Tta-Dfp | (Reaction | Ru Precursor:COF |
| No. | (RuCl₃•xH₂O) | COF | solvent) | Ratio |
| 1. | 60 mg | 20 mg | 10 ml | 3:1 |
| 2. | 40 mg | 20 mg | 10 ml | 2:1 |
| 3. | 20 mg | 20 mg | 10 ml | 1:1 |
| 4. | 10 mg | 20 mg | 10 ml | 1:2 |
| 5. | 5 mg | 20 mg | 10 ml | 1:4 |

In some embodiments, a ratio (by weight) of metal (Ruthenium) to Tta-Dfp COF in the catalyst is between about 1:4 and about 4:1. In other embodiments, the ratio is between about 1:1 and about 3:1. In other embodiments, the ratio is about 1:4, about 1:2, about 1:1, about 2:1, and about 3:1.

In some embodiments, a concentration of the metal in the catalyst is between about 1 and about 5 ppm. In some embodiments, the concentration is about 1.5 ppm, about 2 ppm, about 2.5 ppm, or about 3 ppm.

In some embodiments, an NH₃ yield rate of the catalyst is at least 2.0 mg h⁻¹ mg _{cat}⁻¹ at −0.15 V, relative to a reversible hydrogen electrode (RHE). In some embodiments, a Faradaic efficiency (F.E.) of the catalyst is at least 50%.

The Ru-Tta-Dfp COF catalyst described herein overcomes the challenges of traditional NRR catalyst design, where it is difficult to separate the desirable NRR from the electron-stealing HER and complex electrode structures. By reducing the side reaction, the Ru-Tta-Dfp COF catalyst can be used as a potential cathode for NRR electrolysers, which increases durability and provides cost-effectiveness to the NRR technology. Moreover, pioneering NRR COF catalysts need two independent systems to achieve proton filtration and catalytic conversion, resulting in complicated electrode fabrication and catalytic inconsistency. The use of an in-situ Proton filtering NRR catalyst like those provided herein rules out former challenges, and a single catalyst takes on both filtration and catalytic conversion roles. The simplest design ensures straightforward electrode fabrication and consistent performance, which are the key advantages for commercial-level purposes. Additionally, in principle, for developing an efficient, durable, and selective electrocatalytic CO₂ reduction reaction (CO₂RR) catalyst, the in-situ proton filtering catalyst design of Ru-Tta-Dfp COF is useful considering that HER is also the major side reaction in CO₂RR.

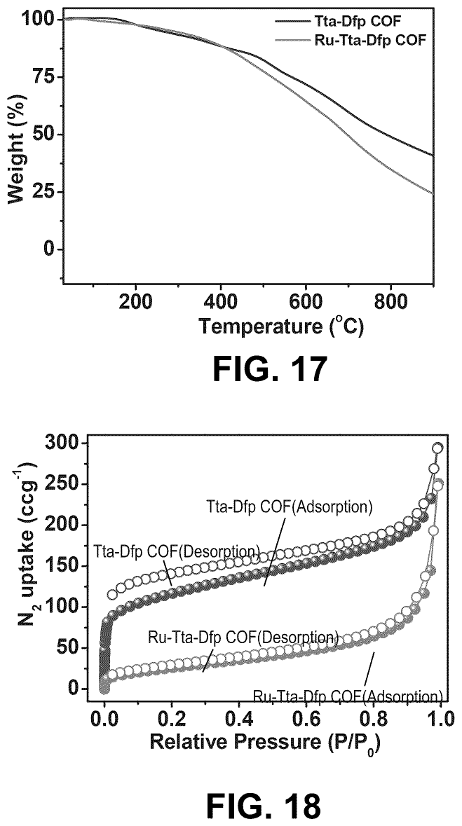

The Ru-Tta-Dfp COF catalyst provides the following additional commercial advantages: (1) synthesis conditions use an ambient temperature (about 25° C.) and time (24-48 hours) of stirring, including without any inert atmosphere; (2) high yield of product (greater than 90%) and (3) scale up (gram to kilogram) viability. The superior activity of the Ru-Tta-Cfp COF, for example as compared to other COFs, may be attributed to synergy between the proton filtering COF framework and the NRR active Ru nanoclusters. The Ru-Tta-Dfp COF exhibited long term stability (for example, up to 400° C.) and reusability. (See, for example. Example 4 below under the Examples section and FIG. 17.)

In some embodiments. Ruthenium can be a preferred metal for use in the COFs described herein, and the COF can preferably be formed from monomers of Tta and Dfp. As described below, alternative metals and alternative structures for the COF can be used for the in-situ proton filtering catalysts described herein. Examples of alternative metals usable in the catalyst include, but are not limited to, nickel (Ni), iron (Fe), cobalt (Co), palladium (Pd), copper (Cu), manganese (Mn), chromium (Cr), molybdenum (Mo), tungsten (W), rhodium (Rh), iridium (Ir), platinum (Pt), gold (Au) and silver (Ag). Various metal precursors of these metals can be used in creating a COF for electrocatalysis and battery applications. The metal catalytic sites can be stabilized to the pore wall by the bis(imino)pyridine ligand present in the Tta-Dfp COF backbone. In examples that use these alternative metals in the Tta-Dfp COF, similar amounts can be used to those provided herein for ruthenium. FIG. 4 shows the PXRD profiles of Fe-Tta-Dfp COF and Cr-Tta-Dfp COF as compared to a pristine Tta-Dfp-COF (i.e. with no metalation) and a simulated PXRD pattern of ideal Tta-Dfp COF. This further supports incorporation of various metal ions in a Tta-Dfp COF. After metalation, the COF network is intact, as indicated by the peak retention of non-metalated Tta-Dfp COF.

In some embodiments, alternative structures to the Tta-Dfp COF can be used in the in-situ proton filter catalysts disclosed herein. The Tta-Dfp COF is formed from a Tta monomer and a Dfp monomer.

Tta Monomer: The strong van der Waals interactions between the Tta-Dfp framework and N₂ can accelerate mass transport and increase the local N₂ concentration inside the pores of COFs, and Ruthenium nanoclusters (RuNC) catalytic sites are stabilized to the pore wall by the bis(imino)pyridine ligand (which arises from the Dfp monomer and imine linkage of COF) present in the COF backbone. The nucleophilic triazine parts of the Tta-Dfp framework cause electrostatic interactions with the protons. This may stop most of the active protons from interacting with the catalytic active ruthenium nanoclusters located in the pore of the COF-stabilized bisiminopyridine unit, which may stop the hydrogen evolution reaction (HER). The diffusion of a few protons as a consequence of their small size might assist in the subsequent hydrogenation of adsorbed activated N₂ molecules by Ru catalytic centers to produce NH₃. Hence, nucleophilic triazine moieties in the framework play a key role in in-situ proton filtering. It is thought that similar in-situ proton filtering Tta analog monomer structures may work at least as well at turning N₂ into ammonia.

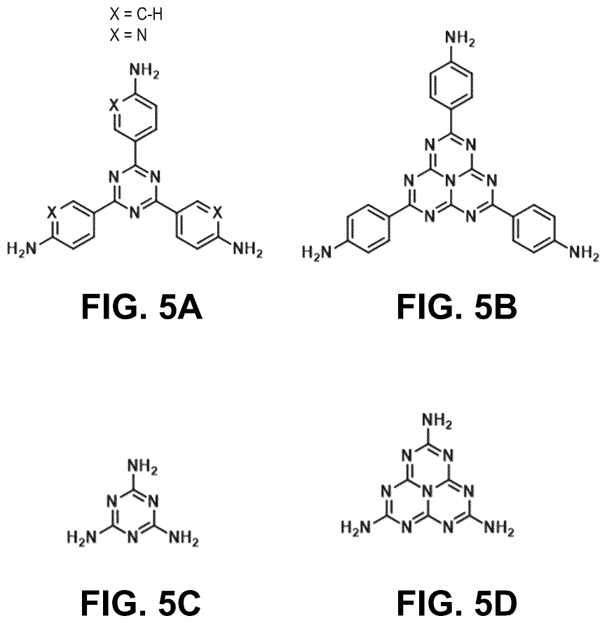

The present disclosure is directed to a metallized COF catalyst that uses COFs based on triazine units, such as Tta monomer or analogs thereof, that work against Dfp monomers. FIG. 5A is a schematic of the Tta structure with X being equal to C—H. Alternatively, if X is equal to N, the derivative of Tta has more nitrogen content. FIGS. 5B-5D are schematics of alternative triazine structures. The structures in FIGS. 5B and 5D are Melem or 2,5,8-triamino-heptazine or 2,5,8-triamino-tri-s-triazine. FIG. 5C is melamine.

Dfp Monomer: A bis(imino)pyridine ligand is found in the backbone of the Tta-Dfp COF. It is made up of a Dfp monomer and an imine linkage of COF. It keeps the ruthenium nanoclusters (RuNC) NRR catalytic sites stable in the COF pore wall. As a result, bis(imino)pyridine ligands that provide an analog of the Dfp monomer (FIG. 4) can make COF systems work as NRR catalysts.

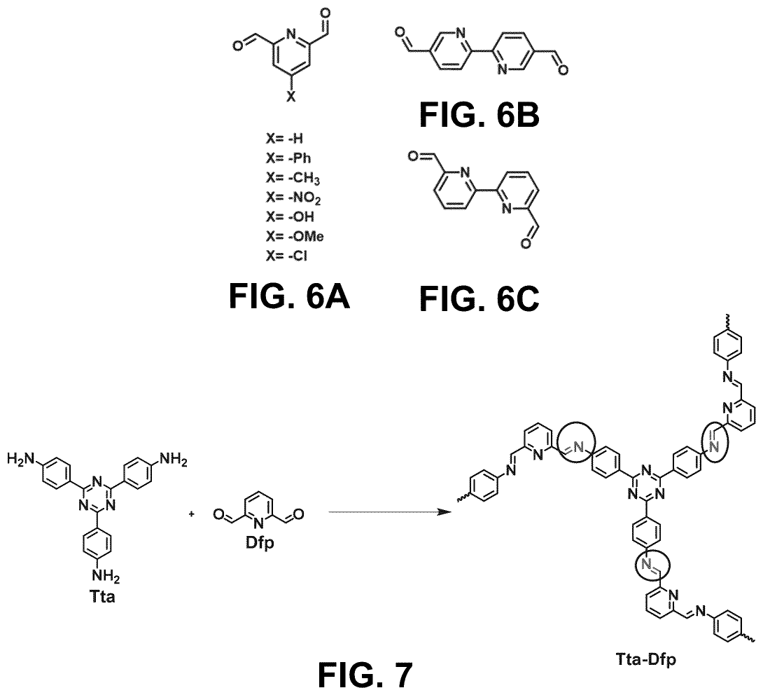

The present disclosure is directed to covalent organic frameworks with pyridine units (Dfp analog monomers) that work against Tta and Tta analog monomers. FIG. 6A is a schematic of the Dfp structure, which is a pyridine carbaldehyde. For Dfp, X is —H. The other options for X provided in FIG. 6A (X=—H, —Ph, —CH₃, —NO₂, —OH, —OMe, and —Cl) can be considered derivatives of Dfp. FIGS. 6B and 6C are schematics of other pyridine carbaldehydes or bipyride dicarbaldehyde derviatives. Specifically, FIG. 6B is a schematic of [2,2′-bipyridine]-5,5′-dicarbaldehyde), and FIG. 6C is a schematic of [2,2′-bipyridine]-6,6′-dicarbaldehyde.

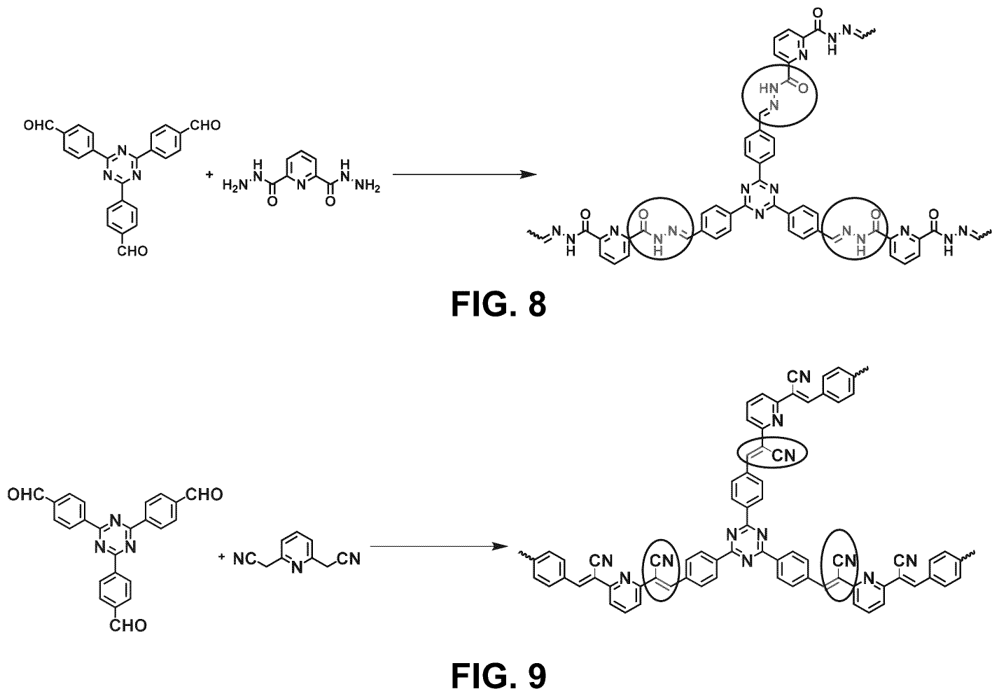

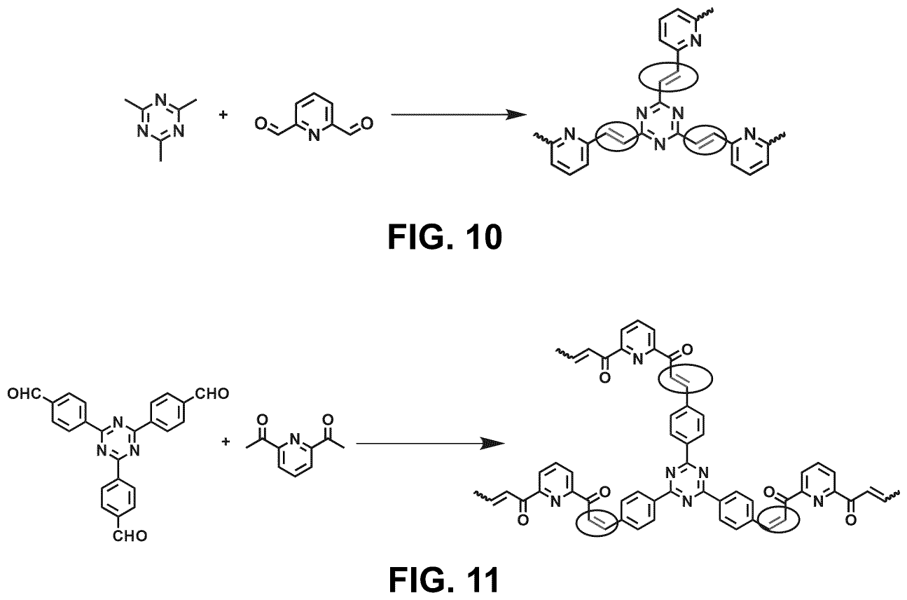

Tta-Dfp COF linkage: FIG. 7 is a schematic of the synthesis of Tta-Dfp to show the imine linkage between Tta and Dfp. A similar triazine and pyridine moiety-incorporated COF design can be used as the in-situ proton-filtering NRR catalyst for ammonia production. In an example, a hydrazone linked Tt-Dfp analog framework can be synthesized by a similar Schiff-base reaction, as shown in FIG. 8. In an example, the sp²-carbon-linked Tt-Dfp analogs framework can be synthesized by Knoevenagel (shown in FIG. 9), Aldol-condensation (shown in FIG. 10) or Claisen-Schmidt reaction (shown in FIG. 11).

Tta-Dfp COF synthesis: The Tta-Dfp COF (before metalation) can be synthesized in some embodiments by a Schiff base condensation of Tta and Dfp, as described in Example 1 under the Examples section below. The resulting catalyst product can be a yellow solid and the yield can be between about 75 and 85 percent, and an average yield is about 80 percent.

In other embodiments, the Tta-Dfp COF can be synthesized through mechanochemical reactions using a mortar and pestle or ball mill machine. The mechanochemical method can be described as follows: a Tta linker (1 molar equivalence) can be directly added to a 1.5 molar equivalent of Dfp and mechano-mixed thoroughly into a solid paste in the presence of a catalytic amount of acetic acid (6M aqueous solution) or p-toluene sulfonic acid. The mixture can be subsequently heated at about 90° C. in a closed container for about 24 hours. The resulting solid monoliths can be washed with N, N-dimethylacetamide (DMA), water, and acetone to obtain Tta-Dfp COF as a yellow solid.

In other embodiments, the Tta-Dfp COF can be synthesized through solvochemical or sonochemical methods, which can be described as follows: a Tta linker (1 molar equivalence) can be directly added to a 1.5 molar equivalent of Dfp and mixed thoroughly in the presence of a catalytic amount of acetic acid (6M aqueous solution) or p-toluene sulfonic acid at about 25° C. by sonicating in continuous mode for about 60 minutes. The reaction can be kept in steady-state for about 24 hours. The resulting solids can be washed with N, N-dimethylacetamide (DMA), water, and acetone to obtain Tta-Dfp COF as a yellow solid. This method can be more energy-efficient and a greener protocol for the synthesis of Tta-Dip COF.

The Ru-Tta-Dfp COF was found to have superior properties as an in-situ proton filtering catalyst, including, but not limited to, thermal stability, high NH; yield rate and F.E. The role of proton filtering was probed using control samples of Ru-Tab-Bda COF and Ru-Tab-Dfp COF, which were synthesized from functional binding blocks. Ru-Tab-Dfp lack nitrogen-rich triazine sites but retains the Ru-coordinating pyridine unit. Ru-Tab-Bda, gives an identical framework, but lacks both triazine sites and the RuNC-binding pyridine unit. Ru-Tta-Dfp was found to perform better than Ru-Tab-Dfp and Ru-Tab-Bda, as provided in Example 11 under the Examples section.

A process for performing in-situ proton filtration and nitrogen conversion using the catalysts described herein can include providing a gas feed that includes N₂. In an example, the gas feed can be generally all nitrogen gas, such as 99.99% purity. The gas feed can be exposed to the catalyst such that the catalyst inhibits proton diffusion through the catalyst and converts Ne to NH₃. The in-situ proton filter catalyst can simultaneously perform in-situ proton filtration and nitrogen conversion.

In some embodiments, the catalyst is cast onto an electrode in the electrochemical cell system that performs in-situ proton filtration and nitrogen conversion. The catalyst can be prepared as a catalyst slurry.

The catalyst used in the process above includes a COF embedded with a metal, the COF having a triazine and pyridine moiety. In some embodiments, the COF moiety is a Tta-Dfp formed by a Tta monomer and a Dfp monomer. In some embodiments, the metal is ruthenium.

The following Examples are intended to illustrate the above invention and should not be construed as to narrow its scope. One skilled in the art will readily recognize that the inventors suggest many other ways in which the invention could be practiced. It should be understood that numerous variations and modifications may be made while remaining within the scope of the invention.

### EXAMPLES

### Materials

4,4′,4″-(1,3,5-triazine-2,4,6-triyl)trianiline (Tta) (TCI), 2,6-diformylpyridine (Dfp) (TCI), Ruthenium chloride (RuCl₃·xH₂O) (TCI), 1,3,5-tris(4-aminophenyl)benzene (Tab) (TCI), Benzene-1,4-dicarboxaldehyde (Bda) (TCI), 1,4-dioxane (Sigma-Aldrich), mesitylene (Sigma-Aldrich), acetic acid (Merck), N, N-dimethylacetamide (DMA) (Sigma-Aldrich), acetone (Merck), methanol (Fisher Scientific), were used as received. All the reactions were carried out in oven dried 35 ml heavy walled (HW) pressure glass vessel capped with Teflon screw cap with rubber internal thread under an air atmosphere unless otherwise mentioned.

The chemicals used for ammonia quantification of products are; ammonium chloride (NH₄Cl, 99%), salicylic acid (C₇H₆O₃, 99.5%), sodium nitroprusside (CsFeN₆Na₂O, 99%), para-dimethylaminobenzaldehyde (p-C₉H₁₁NO, 99%), sodium nitrate (NaNO₃, 99%), sodium nitrite (NaNO₂, 98%), sulphanilamide (C₆H₈N₂O₂S, 99%), N-(1-Napthyl)ethylenediamine dihydrocholoride (C₁₂H₁₄N₂, 99%), mercuric (II) iodide (HgI₂), sodium potassium tartrate (C₄H₄O₆KNa·4H₂O), hydrazine monohydrate (N₂H₄·H₂O, 99%), sodium hypochlorite solution (NaClO, 4-6%) and hydrogen peroxide solution (H₂O₂, 5%) were purchased from Loba Chemic. For isotope experiments, ¹⁵NH₄Cl (99%) was purchased from Cambridge isotope laboratories. All the solutions were prepared using deionized water obtained from Millipore system (15 MΩ). All the analytical grade reagents used in this study such as potassium hydroxide (KOH, 85%), sodium hydroxide (NaOH), hydrochloric acid (HCl; 37%), and ethanol (C₂H₅OH; 99%) were purchased from Loba chemie and Merck respectively and were used as such without further purification and, Nafion N117 membrane fitted in a homemade H-cell setup was bought from DuPont. High-purity ¹⁴N₂ (99.999%), ¹⁵N₂ (99%), and Ar gas (99.999%) cylinders were purchased from Sigma. All the chemicals and reagents used in this study were of analytical grade and used as such without purification and the deionized water was obtained from Millipore system (>14 MΩ cm⁻¹).

### Example 1—Solvothermal Synthesis of Tta-Dfp

Tta-Dfp was synthesized by Schiff base condensation of 2,6-diformylpyridine (Dfp) (11.43 mg, 0.084 mmol) and 4,4′,4″-(1,3,5-triazine-2,4,6-triyl)trianiline (Tta) (20 mg, 0.056 mmol) in 2 mL of 1,4-dioxane/mesitylene mixture (1:1v/v). The reaction was conducted in a sealed pressure tube with a catalytic amount of acetic acid (50 μl, 6M). After heating at 120° C. for five days, the yellow precipitate was collected by centrifuging and washed several times with N, N-dimethylacetamide (DMA), water, and acetone to remove any impurities and unreacted products. This was followed by drying the sample at 80° C. for 12 hours under vacuum, Tta-Dfp COF was obtained as a yellow solid in 82% (26 mg) isolated yield.

### Example 2—General Ruthenium Metalation of Tta-Dfp COF

Metalation was achieved by dissolving the required metal precursor Ruthenium (III) chloride (RuCl₃·xH₂O), in 10 ml methanol, followed by 10 minutes sonication. Next, 20 mg of the well-grounded COF (Tta-Dfp) powder was added to the prepared RuCl₃ solution and stirred at room temperature (25° C.) for 48 hours. Following the end of the reaction, the product was recovered by centrifugation, washed multiple times with methanol, and dried at 60° C. for 12 hours under vacuum.

### Example 3—Size and Structure of Ruthenium Nanoclusters in Ru-Tta-Dfp

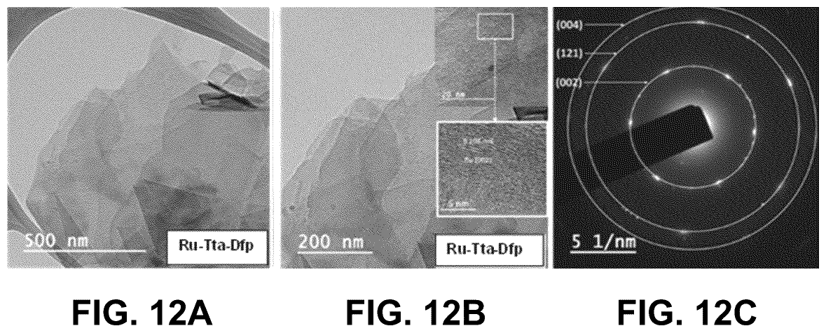

To investigate the size and structure of ruthenium nanoclusters in Ru-Tta-Dfp, high-resolution transmission electron microscopy (HRTEM) analysis was done. FIG. 12A is a HRTEM image before NRR. FIG. 12B is a HRTEM magnified image after NRR, with the inset in FIG. 12B showing the lattice fringes. FIG. 12B revealed the lattice fringes corresponding to the (002) plane of Ru with a d-spacing of 0.208 nm (FIGS. 12A-12C). Hence, the probable diameter of the particle can be estimated at around 4.16 Å. So, from the reported Ru nanocluster structure models, the most matching one is a cubic Ru nanocluster with an average size of 4.28 Å (Ru₁₃) and 8.56 Å (RU₆₃).

As per the Brunauer-Emmett-Teller (BET) pore size distribution of Ru-Tta-Dfp, it showed a maximum pore size distribution at 1.53 nm (15.3 Å), which is consistent with the suggested structural model. The pore size of Tta-Dfp COF is suitable to encapsulate the formerly mentioned-sized Ru nanoclusters inside the pores of COF.

### Example 4—Structural Analysis and Characterization of Tta-Dfp and Ru-Tta-Dfp COFs

Tta-Dfp COF synthesized Schiff-base reactions of Tta with Dfp, and Ru metal centers were incorporated into the Tta-Dfp COF named Ru-Tta-Dfp COF by soaking Tta-Dfp COF in ruthenium (III) chloride solution under constant stirring for 48 hours, followed by methanol washing.

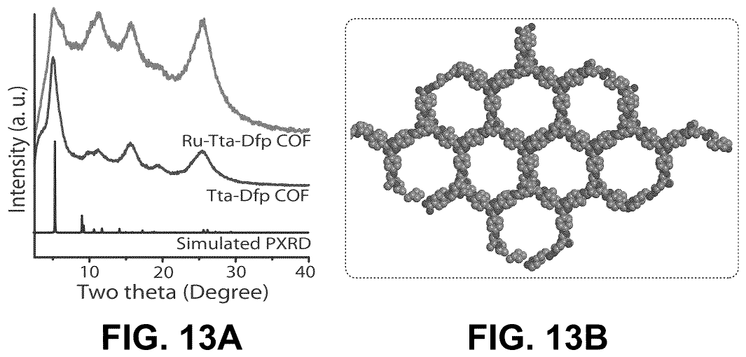

The powder X-ray diffraction (PXRD) analysis was performed to study the structural periodicity of Tta-Dfp and Ru-Tta-Dfp COFs. See FIG. 13A. The PXRD pattern of pristine Tta-Dfp COF (before metalation) reveals an intense peak at 2θ=5°, corresponding to the (110) plane (d-spacing of 17.6 Å). The π-π stacking between adjacent 2D-COF layers produces a peak at 2θ=25.7° matches the (003) plane. The layer-stacked structures with an ABC sequence had the best agreements between the experimental and simulated PXRD patterns (Rwp=6.22% and Rp=6.19%). It is important to note that the (110) plane lies across the π-π-stacked 2D layers whereas the (003) plane lies parallel to the 2D layers of COF. Holistically, if there are more π-π-stacked layers, there is better intensity of the (110) plane peak. During the delamination of stacked 2D layers as a result of the intercalation of Ru nanoclusters, the stacked layers are peeled off from the bulk, which directly affects the intensity of the (110) plane and therefore the peak intensity of the (110) plane is reduced, which is further reflected in the peak intensity ratio of (110)/(003) [i.e., the peak intensity of (110) in Tta-Dfp decreased after the Ru incorporation. As a result, the relative peak intensity ratio of (110) and (003) peaks are sharply reduced from 3.33 (for Tta-Dfp) to 1.07 (for Ru-Tta-Dfp)]. Such intercalation-assisted-layer delamination processes have been widely observed in 2D materials including in the formation of covalent organic nanosheets.

Note that after Ru metalation, the peak is located at the same 20-5, giving the same d-spacing of the Ru-Tta-Dfp COF as the pristine Tta-Dfp COF.

FIG. 13A shows the PXRD pattern of Ru-Tta-Dfp COF, Tta-Dfp COF and simulated PXRD. On the other hand, Ru-Tta-Dfp COF shows similar peaks to pristine Tta-Dfp COF, confirming the removal of RuCha crystalline phase. The metal-doped COF shows a lower peak intensity at 2θ=5° compared to pristine Tta-Dfp COF likely because the intercalated Ru-clusters delaminate stacked layers. The pyridine units are known to act as a mild reducing agent and therefore abundant pyridine units within Tta-Dfp COF act as an in-situ reducing agent for the reduction of RuCl₃ into Ru (0) nanocluster (NC). FIG. 13B is a top view schematic of the layered Tta-Dfp COF resulting from eclipsed AA stacking. Adjacent COF layers have atoms stacked directly on top of each other. This layered stacking structure typically affords an interlayer distance of about 3 to about 4 Å, which is in the range of the pi-pi stacking distance of aromatic units. As such, layers are stabilized by these supramolecular interactions.

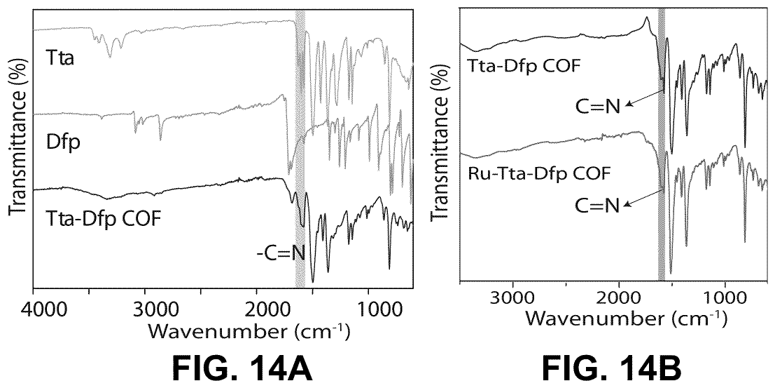

The COFs were characterized through FT-IR spectroscopy to understand the bonding of Tta-Dfp COF, RuNC, and Tta-Dfp COF in Ru-Tta-Dfp COF (FIG. 14A). The FT-IR spectrum confirms the successful imine condensation reaction in Tta-Dfp COF by showing a —C═N— stretching vibration at 1690 cm⁻¹, and significantly attenuated intensity of stretching bands corresponds to C═O (1720-1735 cm⁻¹), and the NH₂ (amine) groups (3300-3400 cm⁻¹) of Tta and Dfp monomers. Notably, the FTIR spectrum of Ru-Tta-Dfp COF in FIG. 14B shows an apparent red-shift and substantial broadening of the C—N peak, signifying the coordination of Ru (0) NC to the pyridinic N atoms within the framework.

The Ru-Tta-Dfp COF also generally follows AA stacking similar to pristine Tta-Dfp COF. However, the Ru nanocluster incorporation exfoliates AA-stacked COF layers, which is reflected in the reduced peak intensity of the Ru-Tta-Dfp COF in the PXRD.

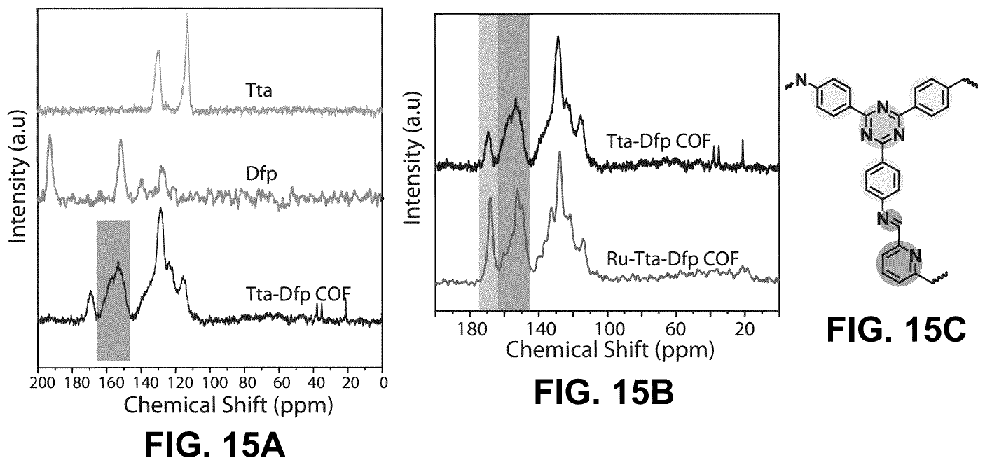

To elucidate molecular level characterizations further, ¹³C cross-polarization magic-angle spinning nuclear magnetic resonance (¹³C CP-MAS NMR) spectroscopy was also used. FIG. 15A shows the ¹³C CP-MAS NMR of the Tta monomer, Dfp monomer and Tta-Dfp COF. The peak at about 45 ppm for the spectrum of Tta-Dfp is due to a trace amount of dimethylacetamide (DMA) that was trapped within Tta-Dfp pores during the purification step. These trace amounts of DMA could not be completely eliminated from the micropores and interlayers of COF even after multiple washes with water and acetone.

FIG. 15B compares the ¹³C CP-MAS NMR between Tta-Dfp COF and Ru-Tta-Dfp COF. The peak observed at ˜157 ppm corresponds to the distinctive imine carbon atom (—C═N), whereas the carbon atoms of the phenyl and triazine groups are responsible for the signals at 120, 126, 130, 150, and 167 ppm, matching the chemical structure of Tta-Dfp COF. The lack of a considerable shift of signals in Ru-Tta-Dfp COF in comparison to pristine COF implies that the chemical structure of COF is intact after Ru incorporation. It is noteworthy that in FIG. 15B the peaks corresponding to DMA (described above in reference to FIG. 15A) disappeared in the spectrum of Ru-Tta-Dfp, after Ru nanocluster intercalation and exfoliation of COF layers.

FIG. 15C is a schematic of the structural building unit of Tta-Dfp COF.

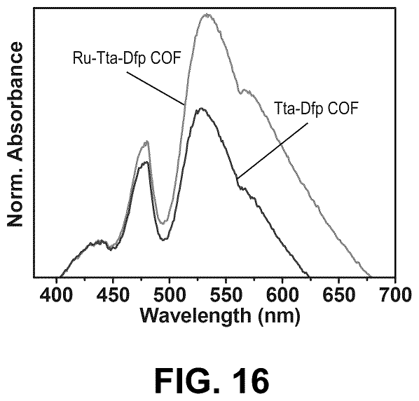

Solid-state diffuse reflectance UV-Visible absorption spectroscopy was used to characterize the COFs and comprehend the absorption features. As shown in FIG. 16, the UV-vis spectra of both Tta-Dfp COF and Ru-Tta-Dfp COF showed peaks at 430 and 475 nm indicative of pyridine, triazine π-π*, and n-π* transitions respectively and a broad band at 525 nm resulted from the delocalized π-electron cloud of Tta-Dfp COF.

There is a trace amount of shoulder peak at 570 nm in the UV-visible absorption spectra of Tta-Dfp, which possibly resulted from weak charge transfer between electron-rich benzene donor to a relatively electron-deficient triazine acceptor. However, there are two important observations: 1) the shoulder peak intensity at 570 nm for Tta-Dfp is much lower than that for Ru-Tta-Dfp and 2) more importantly, the absorption band ends at 620 nm for Tta-Dfp whereas the same band spreads up to 675 nm Ru-Tta-Dfp, which is also evidenced by the color change of Tta-Dfp from yellow to brownish black in Ru-Tta-Dfp. These observations signal that the relatively high-intensity shoulder peak in Ru-Tta-Dfp was a result of the combined effect of charge transfer between the Ru (0) nanoclusters d orbital and the nitrogen-rich ligands iminopyrdine and triazine π* orbitals. There is a charge transfer transition, between Ru-pyridine units, demonstrating the effective interaction of Ru (0) NC with pyridine units in stabilizing Ru-NC within Ru-Tta-Dfp COF.

The thermal stability of COFs were measured by thermogravimetric analysis (TGA). FIG. 17 is a thermogravimetric curve of Tta-Dfp COF and Ru-Tta-Dfp COF. Both Tta-Dfp COF and Ru-Tta-Dfp COF showed thermal stability up to 400° C. with less than 10% weight loss, which indicates thermal stability of Ru-Tta-Dfp COF is not compromised after Ru incorporation.

The porosity features of COFs were investigated by using N₂ gas adsorption analysis at 77K. FIG. 18 shows N₂ adsorption/desorption isotherms of Tta-Dfp COF and Ru-Tta-Dfp COF. The N₂ adsorption studies of Tta-Dfp COF show a type-II adsorption isotherm which is characteristic of microporous materials with a Brunauer-Emmett-Teller (BET) surface area of 417.2 m²/g. The nonlocal DFT (NLDFT) pore size distribution showed a maximum pore size distribution at 1.53 nm, which is consistent with the suggested structural model. Notably, both surface area (100.6 m²/g) and pore size (0.82 nm) of Ru-Tta-Dfp COF were reduced compared to Tta-Dfp COF possibly due to the presence of Ru-NCs within pores and between 2D layers.

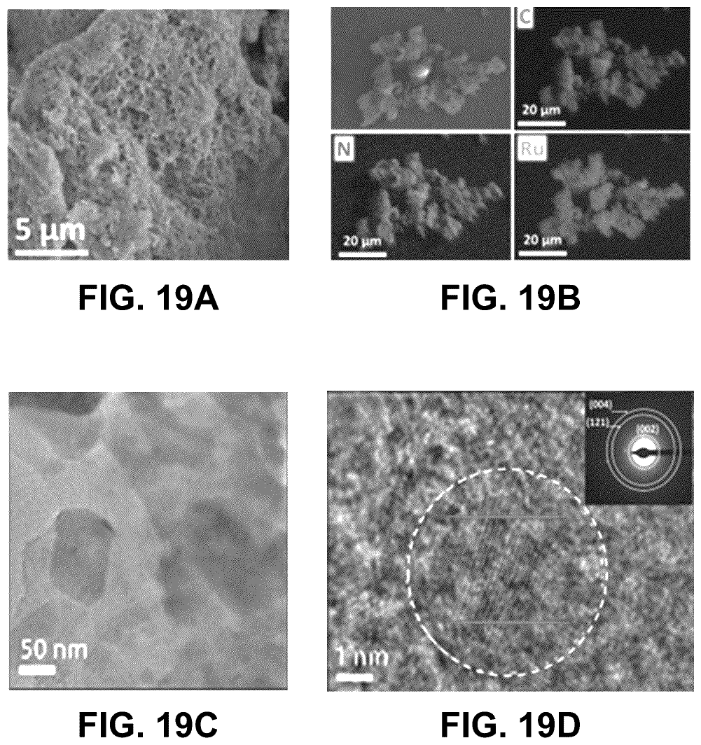

The morphological attributes by scanning electron microscopy (SEM) revealed no distinct feature of the particle in Ru-Tta-Dfp COF (see SEM image in FIG. 19A.) The energy-dispersive X-ray spectroscopic (EDS) elemental dot mapping confirms the coexistence and the uniform distribution of Ru, N, and C throughout the framework (see EDS dot mapping in FIG. 19B.) The transmission electron microscopy (TEM) in FIG. 19C showed layer-like nanostructures, and the high-resolution (HR)-TEM image in FIG. 19D showed the lattice fringes of Ru-NCs with a d-spacing of 0.208 nm, which corresponds to (002) plane of Ru. The selected area electron diffraction (SAED) pattern in the inset of FIG. 19D depicts the presence of the planes viz. (002), (121), and (004) of Ru, which confirms the presence of Ru-NC incorporated within Ru-Tta-Dfp COF.

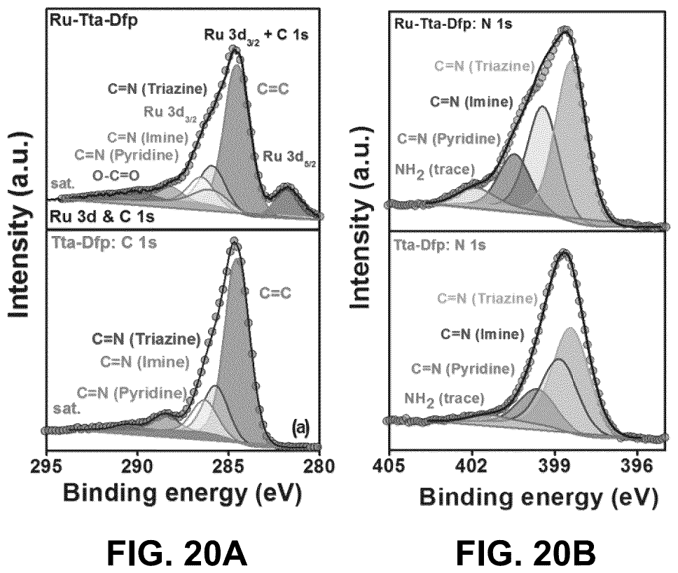

FIG. 20A shows the deconvoluted XPS spectra of Ru 3d and C Is of Ru-Tta-Dfp COF and C Is of Tta-Dfp COF. FIG. 20B shows the deconvoluted XPS spectra of N Is of Ru-Tta-Dfp COF and Tta-Dfp COF. The XPS studies demonstrated the chemical states of the elements in Tta-Dfp COF and Ru-Tta-Dfp COF. The XPS survey spectra of Tta-Dfp COF and Ru-Tta-Dfp COF disclose the presence of C 1s, N 1s, and O 1s at binding energy (BE) of ˜284 eV, 396.9 eV and 532 eV respectively while the additional peak at a BE of 284 eV and 473 eV were observed for Ru 3d and Ru 3p respectively and no impurities were observed for Ru-Tta-Dfp COF. The high-resolution XPS peak deconvolution for all the elements in Tta-Dfp COF and Ru-Tta-Dfp COF confirmed the expected chemical environments for C 1s and Ru 3d (FIG. 20A), N 1s (FIG. 20B), O 1s, and Ru 3p in Tta-Dfp COF and Ru-Tta-Dfp COF. In summary, XPS data indicate that the nitrogen-rich basic sites of Tta-Dfp completely convert the Ru³⁺ chemical state of RuCl₃ into metallic Ru (0) NC in Ru-Tta-Dfp COF. Tta-Dfp COF consists of tridentate NNN ligand in the form of bis(imino)pyridine. Considering the porous nature of Tta-Dfp, Ru metal centers can easily diffuse inside the pores, which in turn bring coordinating ligand into metal proximity. As a result, metal centers can have coordinating interactions with the chelating sites via charge dipole interactions. These factors can stabilize the Ru-nanoclusters within the pores. Similar stabilizations of nanoparticles and nanoclusters by bis(imino)pyridine and pyridine units are well-proven. Moreover, the considerable shifts of N Is peaks corresponding to the C═N (imine) and C═N (pyridine) for Ru-Tta-Dfp COF in comparison with pristine Tta-Dfp COF suggest that these binding units in the Ru-Tta-Dfp COF stabilize Ru-NCs.

### Example 5—Electrochemical Characterization

The potential efficacy of Ru-Tta-Dfp COF towards electrochemical NRR was investigated using a two-compartment H-cell. A control sample of Tta-Dfp COF (metal-free) was also studied for NRR as a side by side comparison.

Prior to any NRR experiment, the gas supplies such as Ar, ¹⁴N₂, and ¹⁵N₂ were tested for any NOx or NH₄⁺ impurities, where the presence of around 0.5-2 ppm of NOx/NH₄⁺ contaminations (Table 2) were quantified by UV-VIS spectroscopy and gas chromatography-mass spectrometry (GC-MS), which could lead to the overestimation of NH₃ yield. This overestimation was eliminated by utilizing a purification setup⁵¹ comprised of alkaline KMnO₄ (to trap NOx) and an acidic trap (to capture NH₄⁺) which could completely capture the impurities present in gas-supplies (Table 3). Therefore, all the NRR experiments were performed by passing the gas-supplies through this purification setup to eliminate the false estimation of produced NH₃.

TABLE 2
Detection and quantification of NOₓ/NH₄⁺ impurities
in commercial gas-supplies before purification

| | | Before purification | | |
|---|---|---|---|---|
| S. No. | Gas supply | NO/NO₂ | N₂O | NH₄⁺ |
| 1. | Ar (99.99%) | 0.6 ppm | <0.01 ppm | — |
| 2. | ¹⁴N₂ (99.99%) | 1.1 ppm | 0.06 ppm | 0.09 ppm |
| 3. | ¹⁵N₂ (98%) | 1.2 ppm | 0.07 ppm | 0.08 ppm |

TABLE 3
Detection and quantification of NOₓ/NH₄⁺ impurities
in commercial gas-supplies after purification

| | | After purification | | |
|---|---|---|---|---|
| S. No. | Gas supply | NO/NO₂ | N₂O | NH₄⁺ |
| 1. | Ar (99.99%) | — | — | — |
| 2. | ¹⁴N₂ (99.99%) | <0.01 ppm | <0.01 ppm | <0.01 ppm |
| 3. | ¹⁵N₂ (98%) | <0.01 ppm | <0.01 ppm | <0.01 ppm |

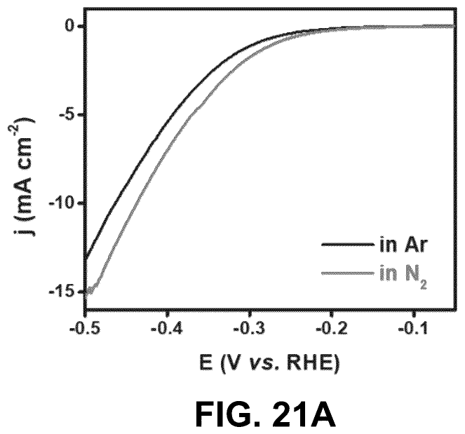

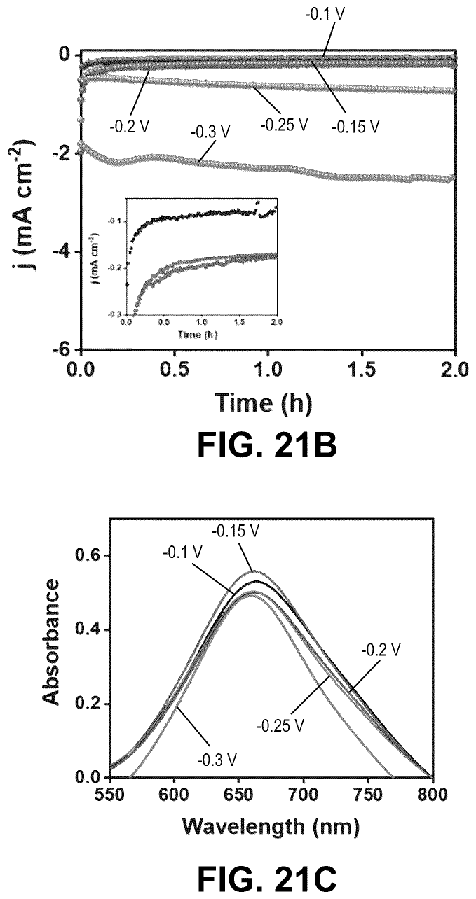

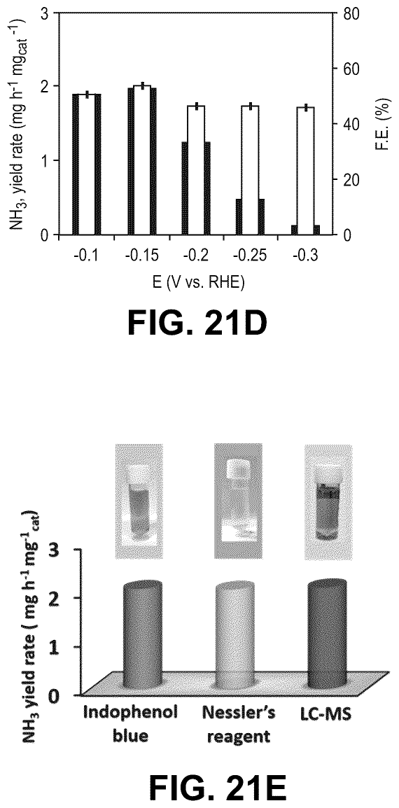

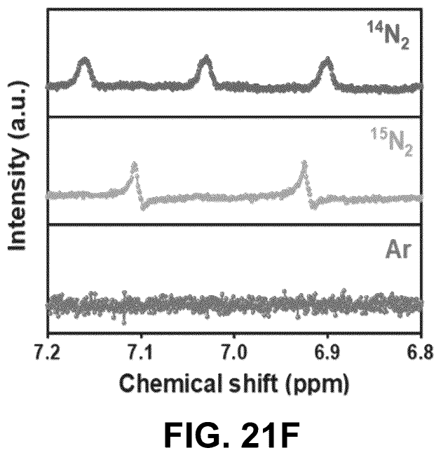

Linear sweep voltammetric (LSV) experiments were performed for of Ru-Tta-Dfp COF in Ar— and N₂-saturated 0.1 M H₂SO₄ (pH=1) electrolyte. FIG. 21A shows the LSV curves of Ru-Tta-Dfp COF at a scan rate of 25 mV s⁻¹—there was no appreciable increase in the reduction current density till-0.2 V (vs. RHE) in the absence of N₂, however, as soon as the electrolyte was purged with N₂ the current density increases sharply at −0.15 V and reaches to −15 mA cm⁻² at −0.5 V (vs. RHE), which is indicative of the possible nitrogen reduction reaction by Ru-Tta-Dfp COF. FIG. 21B shows the chronoamperometric curves for Ru-Tta-Dfp COF at various potentials (vs. RHE) in N₂-saturated electrolyte. FIG. 21C shows the UV-Vis spectra for NH₃ quantification (electrolyte sample taken after NRR) via Indophenol blue method. FIG. 21D is a bar diagram representing the NH₃ yield rate and F.E. obtained after NRR for Ru-Tta-Dfp COF at various applied potentials. FIG. 21E is a bar diagram representing the comparison of ¹⁴NH₄⁺ yield rates obtained by various methods for Ru-Tta-Dfp COF (indophenol blue, Nessler's reagent and LC-MS). FIG. 21F is 1H-NMR spectra showing the absence and presence of NH₄⁺ in the electrolyte sample collected after isotope labelling experiment in Ar—, and ¹⁵N₂/¹⁴N₂-saturated 0.1 M H₂SO₄.

In contrast, control experiments using Tta-Dfp COF showed inferior NRR activity to Ru-Tta-Dfp COF, witnessed from its lower current density of −9.5 mA cm⁻² at −0.5 V (vs. RHE).

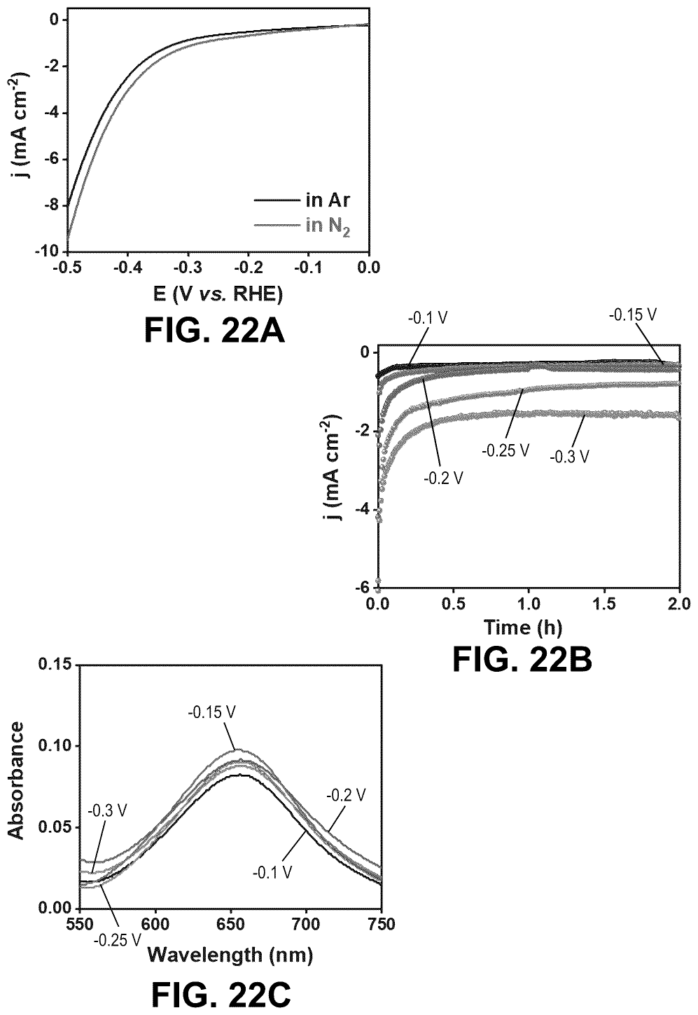

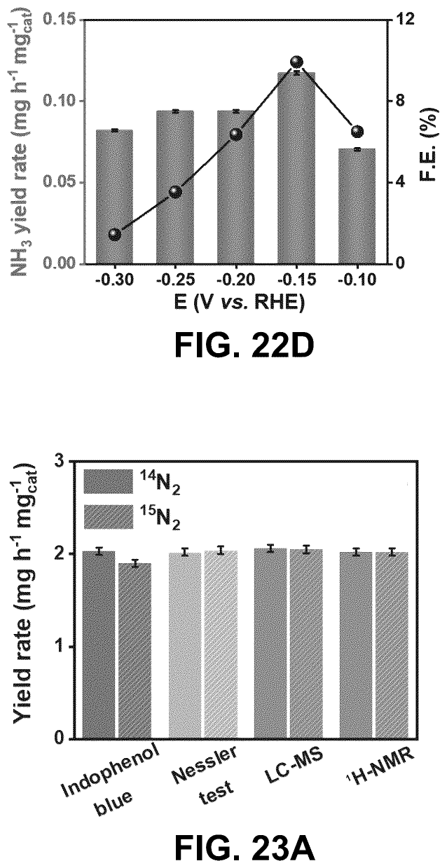

FIG. 22A shows LSV curves for Tta-Dfp in Ar and N₂-saturated 0.1 M H₂SO₄ at 25 mV s⁻¹ of scan rate. To identify and quantify the NRR products (NH₃, N₂H₄), chronoamperometric (CA) analysis was conducted at various applied potentials between −0.1 to −0.3 V (vs. RHE) for Tta-Dfp COF and Ru-Tta-Dfp COF under N₂ saturated conditions-see FIG. 22B as compared to FIG. 21B. FIG. 22C shows the UV-Vis absorbance curves obtained after NH₃ quantification of electrolyte sample taken after NRR via Indophenol blue method. FIG. 22D is a bar graph representing the NH₃ yield rate and F.E. obtained after NRR by Tta-Dfp for 2 hours at various applied potentials. Comparing FIG. 21D and FIG. 22D, both Ru-Tta-Dfp COF and Tta-Dfp COF demonstrate the maximum F.E. and NH₃ yield rates at −0.15 V vs. RHE. In particular, Ru-Tta-Dfp COF exhibits a Faradaic efficiency (F.E.) of 52.9% and delivers a high NH₃ yield rate of 2.03 mg h⁻¹ mg _{cat}⁻¹ at −0.15 V (vs. RHE) with a turnover frequency of 2.03 h⁻¹ respectively. This activity is better than most of the reported literature for NRR in acidic media as shown below in Table 4.

TABLE 4
Comparison of NRR activity of Ru-Tta-Dfp with reported literature in acidic media

| | | | Potential | |
|---|---|---|---|---|
| Catalyst | Electrolyte | NH₃ yield rate | vs. RHE | F.E. |
| Ag nanosheets | 0.1M HCl | 4.62 × 10⁻¹¹ mol cm⁻² s⁻¹ | −0.6 V | 4.8% |
| Ru on ZIF8 | 0.05M H₂SO₄ | 120.9 μg h⁻¹ mg_{Ru}⁻¹ | −0.2 V | 29.6% |
| derived carbon | | | | |
| B—Ag NSs | 0.1M HCl | 26.48 μg h⁻¹ mg⁻¹ | −0.5 V | 8.86% |
| BCN | 0.1M HCl | 7.75 mol cm⁻² s⁻¹ | −0.3 V | 13.79% |
| Ru—ZrO₂ | 0.1M HCl | 3.665 mg_{NH3} h⁻¹mg⁻¹_{Ru} | −0.21 V | 21% |
| NP-C-MOF-5 | 0.1M HCl | 1.08 mol cm⁻² s⁻¹ | −0.1 V | 0.09% |
| Black phosphorus | 0.01M HCl | 31.37 μg h⁻¹ mg⁻¹ (−0.6 V) | — | 5.07% |
| nanosheets | | | | (−0.7 V) |
| NPC | 0.1M HCl | 0.97 mol cm⁻² s⁻¹ | −0.2 V | 4.2% |
| OVs-MoO₂ | 0.1M HCl | 12.2 μg h⁻¹ mg⁻¹_{cat.} | −0.15 V | 8.2% |
| BNC-NSs | 0.05M H₂SO₄ | 15.7 mol cm⁻² s⁻¹ | −0.4 V | 8.1% |
| Single Ag | 0.1M HCl | 270.9 μg h⁻¹ mg⁻¹ | −0.6 V | 21.9% |
| S/N co-doped CC | 0.05M H₂SO₄ | 9.87 × 10⁻¹⁰ mol s⁻¹ cm⁻² | −0.3 V | 8.11% |
| Mo—FeP | 0.1M HCl | 13.1 μg h⁻¹ mg⁻¹_{cat.} (−0.3 V) | — | 7.49% |
| | | | | (−0.2 V) |
| Ni₂P NPs/N, P—C | 0.1M HCl | 11.8 μg · h⁻¹μmg_{cat.}⁻¹ | −0.2 V | 17.21% |
| IrP₂@PNPC-NF | 0.05M H₂SO₄ | 94 μg h⁻¹μmg_{cat.}⁻¹ | −0.2 V | 11% |
| B, O-CMS | 0.1M HCl | 19.2 mol cm⁻² s⁻¹ | −0.25 V | 5.57% |
| TiO₂ nanoarray | PEG + 0.05M | 1.07 μmol cm⁻² · h⁻¹ (−0.5 V) | — | 32.1% |
| electrode | H₂SO₄ | | | (−0.3 V) |
| ECOF@BCP | 0.1M HCl | 287.2 ± 10.0 μg h⁻¹ mg⁻¹_{cat.} | −0.3 V | 54.5 |
| FePc-pz 2D COF | 0.01M H₂SO₄ | 33.6 μg h⁻¹ mg_{cat}⁻¹ | −0.1 V | 31.9% |
| Ti₂N nitride | 0.1M HCl | 11.33 μg/cm²/hr | −0.25 V | 19.85% |
| 1T/2H MoSSe | 0.1M HCl | 32.32 μg h⁻¹ mg_{cat.}⁻¹ (−0.45 V) | — | 12.66% |
| | | | | (−0.4 V) |
| Cu₃P nanoribbon | 0.1M HCl | 18.9 μg h⁻¹μmg_{cat.}⁻¹ | −0.2 V | 37.8% |
| Ru SAs/Ti₃C₂O | 0.1M HCl | 27.56 μg h⁻¹ mg⁻¹ | −0.2 V | 23.3% |
| Ti—COF | 0.05M HCl | 26.89 μg h⁻¹ mg⁻¹_{cat.} | −0.7 V | 34.62% |
| Ru-Tta-Dfp | 0.1M H₂SO₄ | 2.03 mg h⁻¹ mg_{cat}⁻¹ | −0.15 V | 52.9% |

Referring to FIG. 22D, Tta-Dfp COF exhibits inferior NRR activity to Ru-Tta-Dfp COF. Specifically, Tta-Dfp COF had a 9.9% F.E. and 0.12 mg h⁻¹ mgcat⁻¹ yield rate, indicating Ru metal centers' role in N₂ activation and reduction.

Ru-Tta-Dfp COF's activity declines at −0.2 V due to competing HER observed during NRR at identical potential. The H₂ evolution rate of Ru-Tta-Dfp COF shows an increase in H₂ at negative potentials, indicating maximum selectivity at −0.3 V. H₂ production yield rate is 98.3 μmol h⁻¹ mg _{cat}⁻¹ and F.E. is 47.3%. Poor selectivity towards HER is observed at −0.15 V (37.9%), with preferential NRR (52.9%) at less negative potentials. Notably, no hydrazine (N₂H₄) production is observed, indicating selectivity towards NH₃ production. The superior NRR activity of Ru-Tta-Dfp is attributed to higher electrochemical active sites and faster kinetics at the electrode-electrolyte interface, supported by Tafel slope, electrochemical impedance spectroscopic studies (EIS), and electrochemical surface area (ECSA) analysis.

The reason behind the superior activity of Ru-Tta-Dfp over Tta-Dfp towards NRR was evaluated via a series of electrochemical characterizations such as electrochemical impedance spectroscopy (EIS), electrochemical surface area (ECSA) and Tafel plot analysis. EIS was used to determine the interfacial charge transfer resistance (Ret) at the electrode-electrolyte interface from the Nyquist plots. Ru-Tta-Dfp reveals a lower R_{ct} value of 26Ω than that of Tta-Dfp (30 (2) respectively, indicating the facilitated charge transfer at the electrode-electrolyte interface. This improved kinetics could be attributed to the formation of a comparatively thin diffusion layer at the interface and further can be correlated with the low Tafel slope value of 108 mV dec⁻¹ for Ru-Tta-Dfp over Tta-Dfp with a Tafel slope value of 450 mV dec-1 subsequently. Also see Example 12 below for additional electrochemical studies.

### Example 6—Stability and Reusability of Ru-Tta-Dfp COF Catalyst

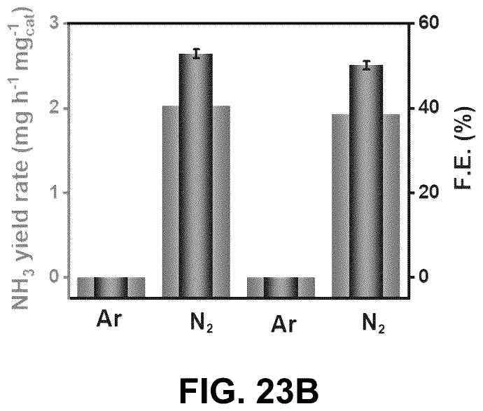

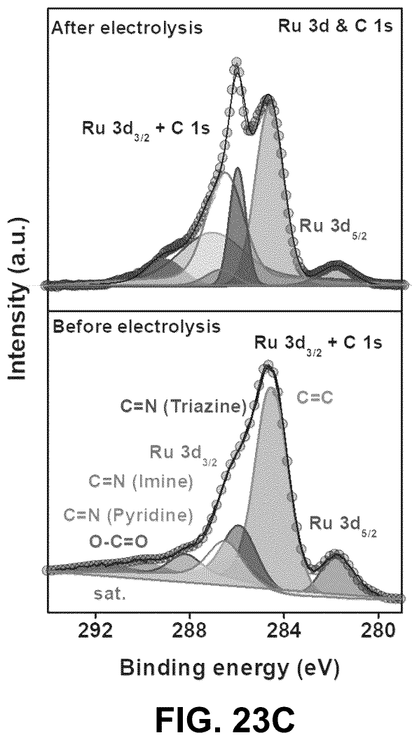

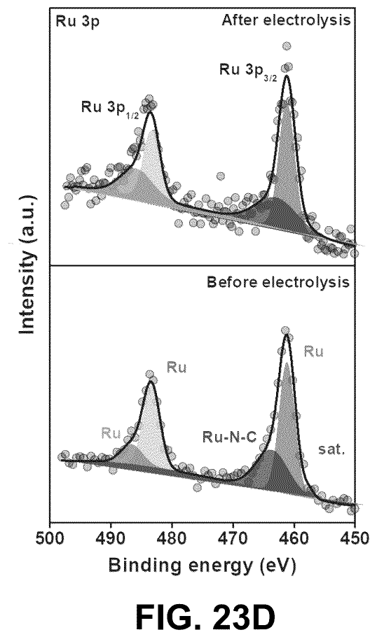

FIG. 23A is a bar diagram representing the comparison of ¹⁴NH₄⁺ and ¹⁵NH₄⁺ yield rates after NRR by Ru-Tta-Dfp COF via various methods. FIG. 23B is a bar diagram representing the NH₃ yield rate and F.E. after switching gas-feed chronoamperometric experiment at −0.15 V vs. RHE. FIGS. 23C and 23D are deconvoluted XP spectra of Ru-Tta-Dfp COF Ru 3d and C 1s (FIG. 23C) and Ru 3p (FIG. 23D) before and after electrolysis in 0.1 M H₂SO₄.

Long-term stability and reusability are crucial for sustainable NRR electrolysis. Ru-Tta-Dfp COF demonstrated high stability for long-term NRR electrolysis, with no decay in current density, NH₃ yield rate, and F.E., indicating its potential for commercial NRR electrolysis. The catalyst is stable in switching gas-feed environments, (Ar and N₂), and no production of NH₃ in Ar while prominent NH₃ production (F.E. 52%) in the presence of N₂ supports the HER suppression by the designed catalyst. The catalyst's structural stability during NRR was examined through post-analysis, revealing Ru metal site retention in the Tta-Dfp framework even after NRR, as revealed by MP-AES analysis. This suggests the significance of Ru in Ru-Tta-DfpCOF as a durable active site for adsorption and activation of N₂ and NH₃ release by hydrogenation via available protons in 0.1 M H₂SO₄. SEM and XPS mapping characterizations show no structural, morphological, or compositional changes after prolonged NRR operation, confirming its stability.

### Example 7—In-Situ Proton Filtration Using Tta-Dfp COF

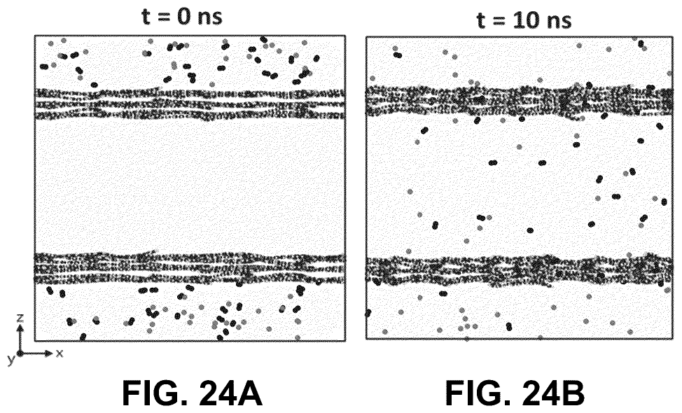

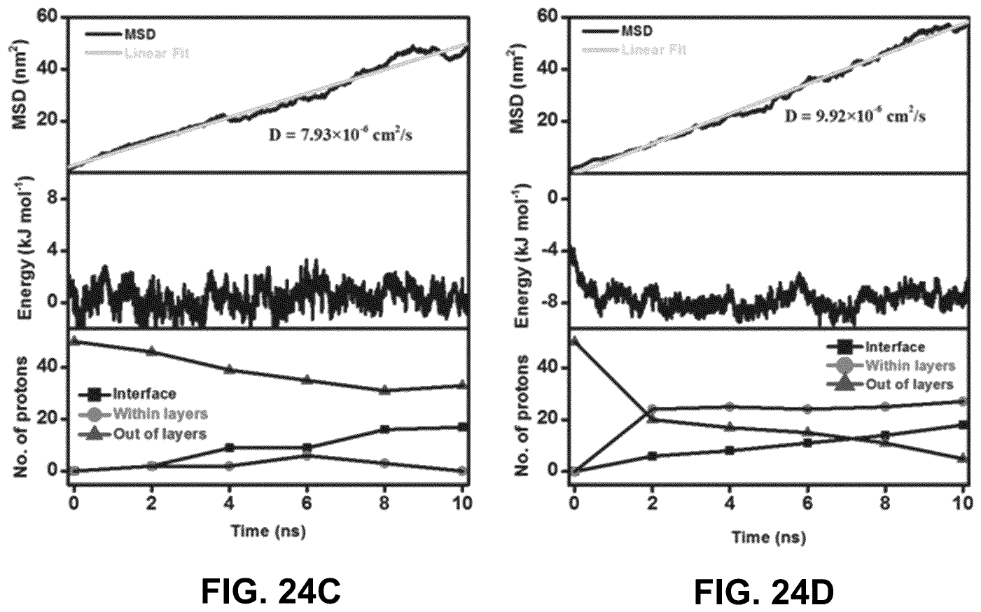

Tta-Dfp COF molecular dynamics simulation (MDS) to investigate H⁺/N₂ diffusion: Simulations were conducted to investigate H⁺/N₂ diffusion through Tta-Dfp COF 2D-layers, calculating mean-square-displacement (MSD), potential energy, and concentration of H⁺/N₂ with time. FIG. 24A is an initial snapshot (time at zero ns) of the diffusion of protons and N₂ molecules through the Tta-Dfp COF layers. FIG. 24B is a snapshot at 10 ns. FIGS. 24C and 24D show calculated mean-square-displacement (MSD), potential energy, and concentration of H⁺N₂ over time.

The initial and final trajectories showed minimal protons interaction while the remaining protons diffused through the 2D layers. MSD reveals a higher diffusion rate of N₂ molecules within COF 2D-layers, attributed to a higher diffusion coefficient calculated from MSD. This difference in the diffusion rate is due to interactions between H⁺/N₂ and the Tta-Dfp COF surface. The positively charged regions generated on COF layers by the diffusion of protons impart repulsive forces, preventing their further diffusion. The material's porosity enables protons and N₂ molecules to diffuse through COF 2D layers. 66% of H⁺ remained outside, while 34% diffused through, leaving no protons within the Tta-Dfp COF layers.

The interactions of the N₂ molecules with the Tta-Dfp COF were dominated by van der Waals (vdW) interactions, which trap the molecules within the layers. Only 10% of N₂ remains outside the layers, while 36% diffuses and 54% are trapped. The porosity within the 2D layers facilitates the diffusion of N₂ molecules. The N₂ concentration changes rapidly in the first 2 ns, as molecules accumulate within the COF 2D-layers. After 2 ns, N₂ saturates within the 2D-layers. The simulation shows a rapid drop in potential energy due to the accumulation of N₂ molecules within COF layers.

In order to investigate the effect of N₂ concentration, another simulation was performed with 100 N₂ molecules. With 100 N₂ molecules, 26% diffused to the interface, while 61% were trapped within 2D-layers, leaving 13% outside the COF layers. The variation of N₂ concentration over time shows that the Tta-Dfp COF layers saturate after 2 ns, like in the previous case (FIGS. 24A and 24B). Both simulations suggest that the diffusion of N₂ molecules are independent of N₂ concentration and the trapped N₂ molecules enhance the NRR activity as it increases the time around the catalytic center in the presence of a metal. This synergistic capabilities of the Tta-Dfp COF in holding and permeability of N₂ molecules, along with the double-mechanism of adsorption and inhibiting the diffusion of protons, suppresses the HER activity and simultaneously provides the best and most dynamic platform for the NRR process.

Further, first-principles calculations were performed to demonstrate the interactions of proton and N₂ molecules with Tta-Dfp. The calculated proton binding energy was found to be −2.38 eV as the H⁺ adsorption was strongly favored with a bond distance of 1 Å. In the case of Ru-Tta-Dfp, the calculated proton binding energy increases to −3.11 eV, a difference of 0.73 eV, confirming the higher proton trapping ability of the Ru-Tta-Dfp for the N₂ reduction reaction.

### Example 8—Quantification of Ru Centres in Ru-Tta-Dfp

Microwave plasma-atomic emission spectroscopy technique (MP-AES) was employed to quantify the metal (Ruthenium) content in the Ru-Tta-Dfp COF catalyst.

The Ru-Tta-Dfp catalyst (3 mg) was dispersed in a mixture of isopropyl alcohol (40 μL) and deionized water (960 μL) and ultrasonicated for 30 min. to get a well-dispersed catalyst slurry. A 10 μL catalyst slurry was then dropped on the GC electrode and dried at room temperature. Using this amount of catalyst, different electrochemical methods were used to measure its activity in electrochemical nitrogen reduction reactions (NRR). The same amount of loaded catalyst was dissolved in a standard nitric acid solution to see the initial Ru concentration before NRR.

The concentration of ruthenium in the extract solution before (and after) NRR was 2.15 ppm. The electrolyte used was 0.1 M H₂SO₄. The concentration of ruthenium in the electrolyte after NRR was not detected. This establishes that there is no leaching of ruthenium during catalysis and ruthenium is stable in the COF matrix during NRR catalysis.

### Example 9—Synthesis of Tab-Dfp COF

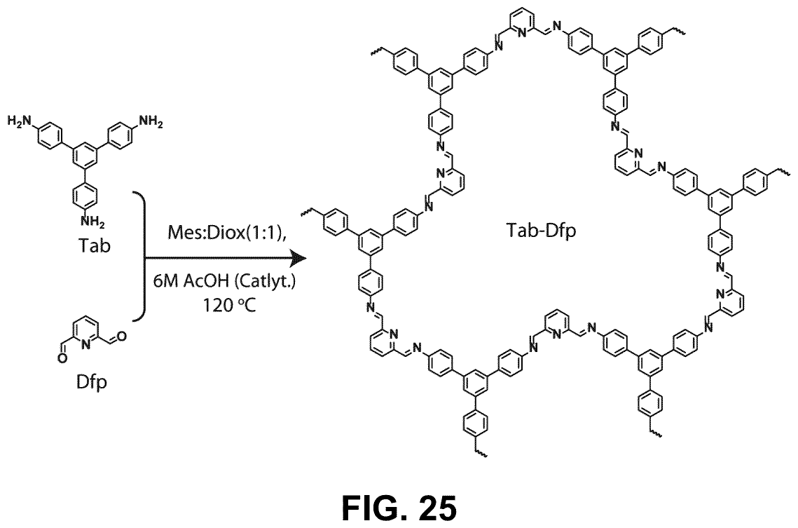

Tab-Dfp was synthesized by Schiff base condensation of 2,6-diformylpyridine (Dfp) (11.53 mg, 0.085 mmol) and 1,3,5-tris(4-aminophenyl)benzene (Tab) (20 mg, 0.056 mmol) in 2 mL of 1,4-dioxane/mesitylene mixture (1:1v/v), as shown in FIG. 25. The reaction was conducted in a sealed pressure tube with a catalytic amount of acetic acid (50 μl, 6M). After heating at 120° C. for five days, the yellow precipitate was collected by centrifuging and washed several times with N, N-dimethylacetamide (DMA), water, and acetone to remove any impurities and unreacted products. This was followed by drying the sample at 80° C. for 12 h under vacuum, Tab-Dfp COF was obtained as a yellow solid in 79% (25 mg) isolated yield.

### Example 10—Synthesis of Tab-Bda COF

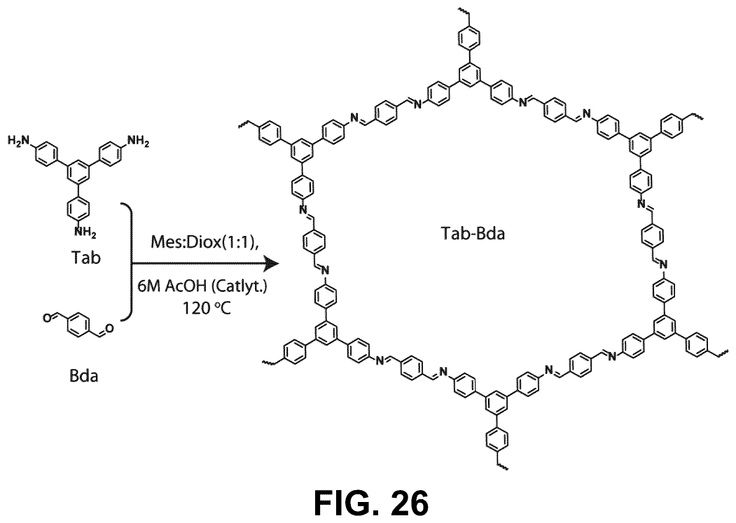

Tab-Bda was synthesized by Schiff base condensation of Benzene-1,4-dicarboxaldehyde (Bda) (11.45 mg, 0.085 mmol) and 1,3,5-tris(4-aminophenyl)benzene (Tab) (20 mg, 0.056 mmol) in 2 mL of 1,4-dioxane/mesitylene mixture (1:1v/v), as shown in FIG. 26. The reaction was conducted in a sealed pressure tube with a catalytic amount of acetic acid (50 μl, 6M). After heating at 120° C. for five days, the yellow precipitate was collected by centrifuging and washed several times with N, N-dimethylacetamide (DMA), water, and acetone to remove any impurities and unreacted products. This was followed by drying the sample at 80° C. for 12 h under vacuum, Tab-Bda COF was obtained as a yellow solid in 76% (24 mg) isolated yield.

### Example 11—NRR Control Experiment of Ru-Tab-Dfp COF and Ru-Tab-Bda COF

Ru-Tab-Dfp COF and Ru-Tab-Bda COF were prepared by following the same protocol for the preparation of Ru-Tta-Dfp COF, characterized using FTIR, PXRD and BC CPMAS NMR, similar to Ru-Tta-Dfp COF.

Under similar NRR experimental conditions, the LSV curves of Ru-Tta-Dfp displayed higher activity in terms of both onset potential and current density than those of other catalysts. Further, CA experiments for Ru-Tab-Bda and Ru-Tab-Dfp under similar experimental conditions were followed by UV-Vis spectroscopy, and revealed an insignificant ammonia production (see Table 5 below), indicating the incompetence of Ru-Tab-Bda and Ru-Tab-Dfp towards NRR. Ru-Tab-Dfp did not exhibit any nitrogen reduction activities and hence there are no F.E. and ammonia yield rates provided in the table below.

TABLE 5
Comparison of NRR activity of Ru-Tta-Dfp COF with control samples

| | | | Potential | | |
|---|---|---|---|---|---|
| Sample | Electrocatalyst | Electrolyte | (vs. RHE) | F.E. | NH₃ yield rate |
| A | Ru-Tta-Dfp | 0.1M H₂SO₄ (pH = 1) | −0.15 V | 52.9% | 2.03 mg h⁻¹ mg_{cat}⁻¹ |
| B | Tab-Bda | 0.1M H₂SO₄ (pH = 1) | −0.15 V | 23.87% | 10.53 μg h⁻¹ mg_{cat}⁻¹ |
| C | Ru-Tab-Bda | 0.1M H₂SO₄ (pH = 1) | −0.15 V | 7.82% | 2.63 μg h⁻¹ mg_{cat}⁻¹ |
| D | Tab-Dfp | 0.1M H₂SO₄ (pH = 1) | −0.15 V | 2.08% | 1.46 μg h⁻¹ mg_{cat}⁻¹ |
| E | Ru-Tab-Dfp | 0.1M H₂SO₄ (pH = 1) | −0.15 V | — | — |

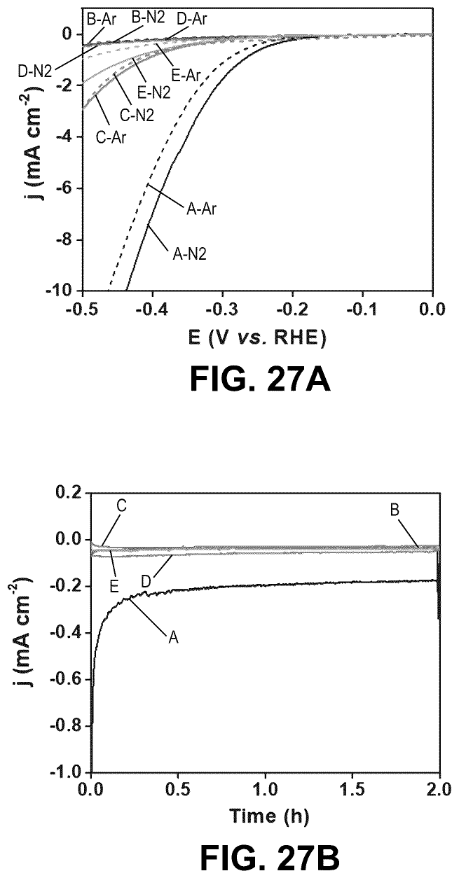

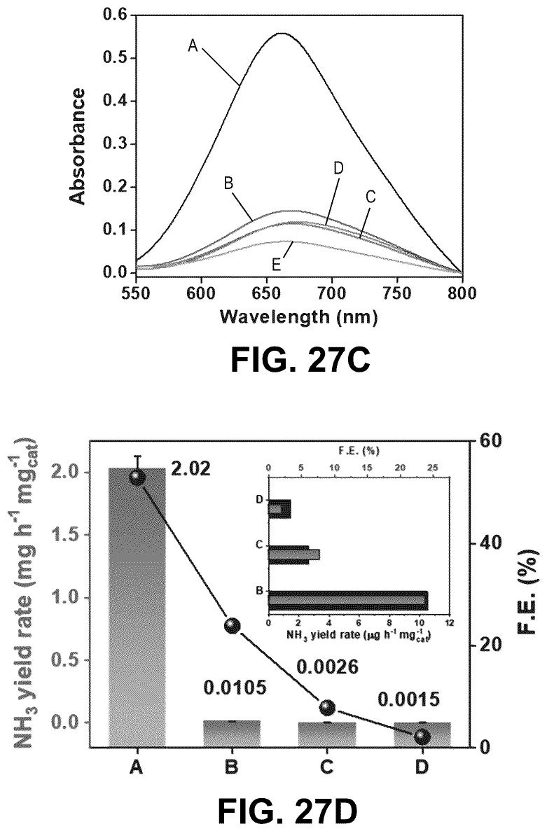

FIG. 27A shows the LSV curves in Ar— and N₂-saturated conditions at 25 mV s⁻¹ for the samples in Table 5. FIG. 27B shows chronoamperometric measurements at −0.15 V vs. RHE for the samples in Table 5. FIG. 27C shows UV-Vis spectra recorded for Indophenol blue test after electrolysis for 2 h at −0.15 V vs. RHE for the samples in Table 5. FIG. 27D is a bar graph of yield rate and F.E. for samples A-D in Table 5.

The findings in Table 5 and FIGS. 27A-27D demonstrate the significance of the rational design of Ru-Tta-Dfp to exhibit outstanding NRR activity in acidic media with excellent efficiency. The superior activity of Ru-Tta-DfpCOF could be attributed to the synergy between the proton filtering COF framework (Tta-Dfp) and the NRR active RuNC present in the catalyst. The concept of in-situ proton filtration in the Ru-Tta-Dfp COF catalyst was further endorsed experimentally by the NRR activity trend of control samples.

### Example 12—Electrochemical Studies

To verify the true source for NH₃ production over Ru-Tta-Dfp, ¹⁵N-labeled isotope experiments were performed along with several other experiments including tracking and eliminating the N-labile impurities in the cell system, electrolyte, and gas supply experiments.

In the beginning, the cell system, electrolyte solutions as well as the gas-supplies were checked for any impurities viz. NOₓ, NH₄⁺ by spectrophotometry and gas chromatography mass spectroscopy (GC-MS) techniques. The commercial gas-supplies used in this study were already purified and made contamination-free. When the reaction was executed in Ar-saturated electrolyte at −0.15 V (vs. RHE) for 2 hours, the NH₃ yield rate was below the detection limit. (See FIGS. 27A-27D) This signifies that self-electrolysis of Ru-Tta-Dfp was not responsible for NH₃ production. Moreover, no NH₃ production was witnessed at open circuit potential, pointing towards the absence of NOₓ or NH₄⁺ impurity in purged N₂ gas-supply. Lastly, the control experiment over bare electrode in N₂-saturated electrolyte was also performed which did not show any appreciable NH₃ formation and thus eliminates the possibility of false NH₃ estimation during NRR. In addition, the electrolytes were also tested for the presence of NO₃⁻ or NO₂⁻ contaminations with the help of UV-Vis spectroscopy, which ruled out any nitrate/nitrite contamination that can lead to overestimation of NH₃ yield.

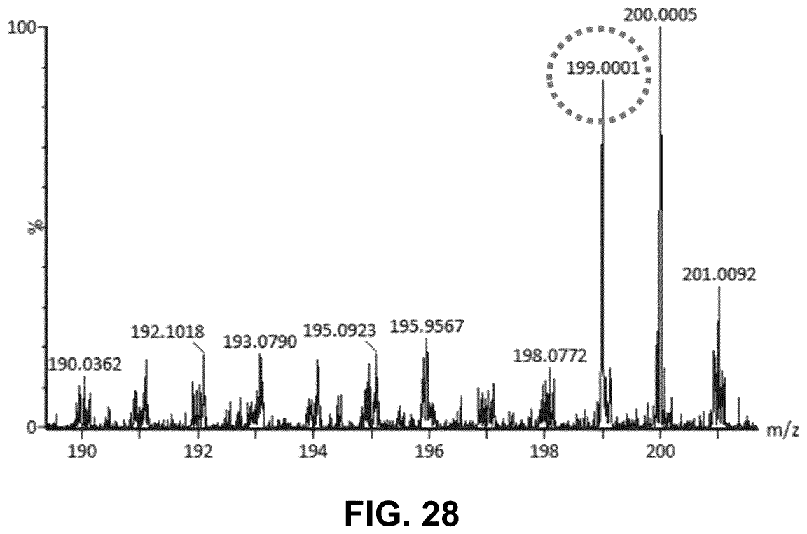

¹⁵N labeled isotope experiments were performed by using Ru-Tta-Dfp and carrying out chronoamperometry at a similar applied potential of −0.15 V (vs. RHE) for 2 hours. After the experiment, the samples were collected and quantified for NH₃ by different methods such as, Indophenol blue method, Nessler's reagent method, LC-MS and ¹H-NMR spectroscopy method. The ¹H NMR spectrum of ¹⁴NH₃ demonstrates a characteristic triplet with a coupling constant value of 53 Hz while a doublet with a coupling constant of 72 Hz is perceived in the NMR spectrum of ¹⁵NH₃. When ¹⁵N₂ is used as a gas-supply to carry out NRR by Ru-Tta-Dfp in 0.1 M H₂SO₄ electrolyte, the NMR spectrum in FIG. 21F reveals a doublet which corresponds to the formation of ¹⁵NH₃ as a product, thus confirming that the chemical origin of the ammonia produced in this study is the N₂ gas supplied into the system rather than any possible N-labile impurities in the system. This origin is further supported by the mass spectrum of FIG. 28 obtained after LC-MS analysis, which shows a prominent peak at m/z value of 199 which is a characteristic of ¹⁵N-indophenol.

In addition, NMR and LC-MS analysis disclose the NH₃ yield rate of 2.02 and 2.05 mg h⁻¹ mg_{cat}⁻¹ at −0.15 V vs. RHE, respectively, which puts forward an analogous trend observed from the bar diagram in FIG. 23A.

For a sustainable NRR electrolysis, the long-term stability and reusability of the catalyst is essential. To evaluate the stability of Ru-Tta-Dfp for long-term NRR, CA analysis was carried out at a fixed potential of −0.15 V for continuous 10 h. The j-t curves showed no decay in the current density (j) over time as well as NH₃ yield rate and F.E., signifying the high stability of Ru-Tta-Dfp towards NRR. The catalyst was even stable under switching gas-feed environments (Ar and N₂). No production of NH₃ in Ar was observed while prominent NH₃ production (F.E. 52%) in the presence of N₂ supports the HER suppression by the designed catalyst (FIG. 23B). The structural stability of the catalyst during NRR was further examined by in-depth post-catalysis analysis of the catalyst. The microwave plasma atomic emission spectroscopy (MP-AES) analysis for Ru-Tta-Dfp before and after NRR discloses the retention of Ru-NCs in the Tta-Dfp framework even after NRR (see Example 8). SEM, EDS, and XPS mapping characterizations of Ru-Tta-Dfp revealed no discernible structural, morphological, and compositional changes even after prolonged NRR operation, attesting its stability.

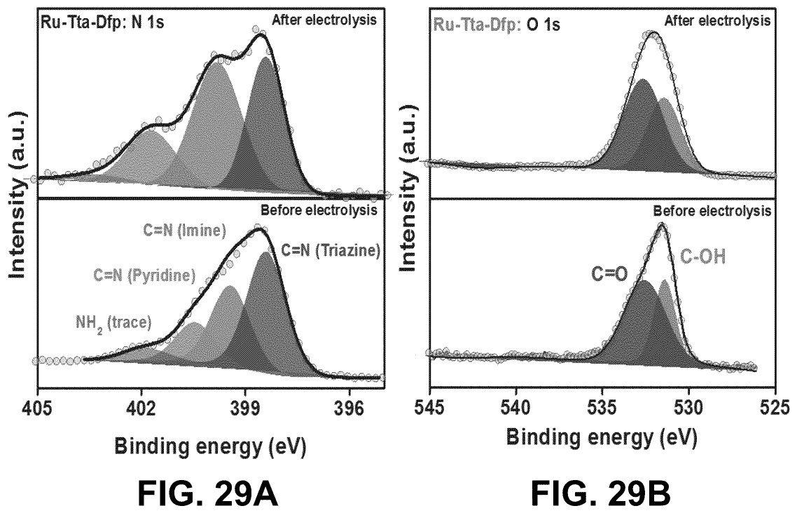

More interestingly, the changes in the electronic structure of the Ru-Tta-Dfp before and after NRR were examined by XPS analysis. FIG. 29A shows deconvoluted XPS spectra for N Is before and after electrolysis. FIG. 29B shows deconvoluted XPS spectra for O 1s before and after electrolysis.

After NRR electrolysis, no significant shift in the BE was observed in Ru 3d+C 1s and Ru 3p XPS spectra, however, the intensity of oxidized N and C—OH in N 1s and O 1s XPS spectra was enhanced due to the surface oxygen during electrolysis in H₂SO₄. Interestingly, the intensity redistribution in deconvoluted Ru 3d XPS spectra after NRR elucidates the contribution of nitrogenous species (triazine and pyridine) towards NRR activity. It is well known that using pyridinic and triazine nitrogen atoms can contribute to electrocatalysis. After closely evaluating the N1s spectra of Ru-Tta-Dfp before and after electrocatalysis, FIG. 29A demonstrates that the intensity and distribution peaks of various nitrogen environments such as imine, triazine, and pyridine were retained, which endorses the contribution of nitrogen-rich sites. More importantly, it proves that the NRR contribution of N-rich sites is not by sacrificial decomposition but exclusively by catalytic conversion. The pristine Tta-Dfp NRR activity also supports the former inference. In short, N-rich sites of Ru-Tta-Dfp have multiple roles, such as in-situ proton filtration, stabilizing the Ru-NCs, and contributing to NRR activity. Although the intensity of Ru 3d peaks was diminished, the retention of Ru-Tta-Dfp electronic structure indicates that the Ru metal remains intact in the COF structure without change in its oxidation state, (Example 8 and FIGS. 23C and 23D) which is consistent with MP-AES analysis.

The presence of the XPS peak feature in the catalyst remains consistent before and after electrolysis, supporting a conclusion that the catalyst maintains its stability through the electrocatalytic process. The O1 peaks remain unaltered over the catalysis process, again providing evidence of stability of the electrocatalyst.

Further, HRTEM images taken after NRR (see FIG. 12B) still revealed the lattice fringes corresponding to (002) plane of Ru with a d-spacing of 0.208 nm. HRTEM maps reveal the homogenous distribution of C, N, O, and Ru even after long-term electrolysis. This remarkable activity and stability of Ru-Tta-Dfp during NRR is conclusive of the potential of metal-incorporated COFs for the selective production of NH₃.

### Instruments and Methods

Powder X-ray diffraction (PXRD): Powder X-ray diffraction measurements were performed on Rigaku Smart Lab II with Cu Kα (λ=1.5405 Å) radiation source operating at 40 kV and 40 mA. The patterns were recorded with divergent slit of 1/16° over the 2θ range of 2-50° with step size=0.02°.

Fourier transform infrared spectroscopy (FT-IR): FT-IR spectra were taken on a Bruker Optics ALPHA-E spectrometer with a universal Zn—Se ATR (attenuated total reflection) accessory in the 600-4000 cm⁻¹ region or using a Diamond ATR (Golden Gate) with 24 scan rate and 4 cm⁻¹ resolution.

Solid-state ¹³Carbon cross polarization-magic angle spinning (CP/MAS): cross-polarization magic angle spinning (CP/MAS) ¹³C NMR spectra of the COFs were recorded on a Bruker Avance 500 Wide Bore (500 MHz) NMR spectrometer at ambient temperature with a magic angle spinning rate of 18.0 kHz. NMR data were processed using Top Spin software.

BET analysis: Porosity analyses were performed using Anton Paar Autosorb iQ combined physisorption and chemisorption instrument. For each measurement, 20-30 mg of COF samples were used. The samples were activated at 80° C. for 16 hours before being subject to N₂ gas adsorption in a liquid N₂ bath (77 K) to collect full isotherms. Surface areas were calculated using the Multipoint Brunauer-Emmett-Teller (BET) model, and pore size distributions were evaluated/calculated using the non-local density functional theory (NLDFT).

Morphology and elemental analysis: The morphology of the materials was characterized by scanning electron microscopy (SEM, JEOL JSM-7610F FEG-SEM. The SEM samples were prepared by drop-casting 10 μL of COFs slurry (COFs dispersed in Isopropyl alcohol) on a silicon substrate and dried in air followed by Pt coating (nano-sized film) using the JEOL JEC-300FC Auto Fine before SEM analysis. Further, transmission electron microscopy (TEM) and high-resolution TEM (HR-TEM) were employed for the in-depth morphological analysis by FEI Tecnai TEM 20 kV. The TEM samples were prepared by drop casting the COFs dispersion (dispersed in Isopropyl alcohol) over carbon grids (TED PELLA, INC. 200 mesh) and allowed to dry overnight in desiccators.

Thermogravimetric analysis (TGA): TGA analysis was performed using a PerkinElmer Simultaneous Thermal analyzer STA 6000 under N₂ environment at a heating rate of 15° C. min-1 and a temperature range of 30-900° C.

X-ray photoelectron spectroscopy (XPS): XPS measurements were performed using a Supra+ instrument (Kratos, Manchester, UK) equipped with an Al K_{α} excitation source and a monochromator. The charge neutralizer was on during the measurements. The take-off angle was 90°. XPS measurements and data processing were performed using ESCApe 1.5 software (Kratos). The powder samples were placed on a carbon tape attached to the silicon wafer. The area analysed was 300 by 700 microns. The measurements were performed at a pass energy of 20 eV. The base pressure in the main analysis chamber was 8.10⁻⁸ mbar. The binding energy scale was corrected based on the C—C/C—H peak at 284.8 eV in the C 1s spectrum.

Electrochemical characterizations: All the electrochemical studies were performed in homemade H-type cell wherein the two compartments were separated by a Nafion N₁₁₇ (proton exchange) membrane. A three-electrode cell setup was utilized with glassy carbon (GC Ø2 mm) as working electrode (WE) and double junction Ag/AgCl/3 M KCl as reference electrode (RE) in one compartment of the cell and graphite electrode as counter electrode (CE) in another compartment. Before conducting the experiments, the Nafion membrane was cleaned thoroughly by first boiling in deionised water (>14 MΩ cm⁻¹) for 30 min., followed by heating in 5% solution of H₂O₂ at 80° C. for 30 min. and finally boiling in 0.05 M H₂SO₄ for 1 h. Glassy carbon (working) electrode was cleaned by polishing it using alumina slurry of different grades (0.3 and 0.05 μm, PINE instrument, USA) on a Nylon cloth (SM407052, AKPOLISH) to get a mirror finishing followed by ultrasonication in DI water and IPA for removal of residual alumina particles.

Further, the catalyst slurry was prepared by first physically grinding the powder in a mortar and pestle to obtain a fine powder. Then 3 mg catalyst was dispersed in a mixture of isopropyl alcohol (40 μL) and deionized water (960 μL) and ultrasonicated for 30 min. to get a well-dispersed catalyst slurry. A 10 μL catalyst slurry was then drop casted on the GC electrode and dried at room temperature. Primarily, the activity of the catalyst towards electrochemical nitrogen reduction reaction (NRR) was measured using various electrochemical techniques viz., linear sweep voltammetry (LSV), chronoamperometry (CA), and electrochemical impedance spectroscopic (EIS) techniques using Biologic VSP 300 potentiostat/galvanostat with FRA7M module run by EC-Lab V11.12 software. All the potentials were reported vs. RHE using equation (1) below.

$${E}_{R H E} = {E}_{A g / A gCl} + {E}_{A g / A gCl}^{0} + 0.0 \; 59 pH \qquad ( 1 )$$

The NRR experiments were performed in 0.1 M H₂SO₄, solutions at a scan rate of 25 mV s⁻¹ under N₂— saturated conditions. Before each experiment, the solution was purged by N₂ (99.999% purity) for 30 mins. The chronoamperometric measurements were recorded at different potentials for 2 hours each. The cycling stability of Ru-Tta-Dfp towards NRR was performed by recording chronoamperometric curves at −0.15 V vs. RHE for 10 h while changing the electrolyte and quantifying the product after every two hours. Similarly, the stability during feed gas switching (N₂—Ar—N₂—Ar) experiments was done at −0.15 V vs. RHE and quantifying the product after every 2 h.

To validate the superior performance of the catalyst towards NRR, electrochemical surface area (ECSA) is an important tool that can directly influence the activity of the catalyst. Hence, ECSA was calculated using double-layer capacitance, Cal. Initially, cyclic voltammetric (CV) measurements were recorded at various scan rates (10-100 mV s⁻¹) in the non-faradaic region (0.15-0.2 V vs. RHE) in N₂-saturated 0.1 M H₂SO₄. The slope of average current density ((jₐ+j_{c})/2 vs. scan rate gives the value of Cal and further divides the slope by specific capacitance, i.e. 40 μF cm⁻² (for planar electrodes, specific capacitance is from 20-60 μF cm⁻²). Calculation of charge transfer resistance (Ret) was done to study the kinetics of the electrode/electrolyte interface using electrochemical impedance spectroscopy. A DC potential of −0.15 V vs. RHE in 0.1 M H₂SO₄ was applied over an AC perturbation of 10 mV between a frequency range of 4 MHz to 1000 Hz in a logarithmic frequency step over a single sine wave. A semicircular behavior was observed in the corresponding Nyquist plot. Ret was calculated from the difference between polarization resistance (Rₚ, obtained at low-frequency region) and solution resistance (Rₛ, obtained at high-frequency region).

### Products Quantification

Ammonia quantification: The electrolyte was collected after chronoamperometric measurements at different potentials and was quantified by various methods;

Indophenol blue method. After 2 h of chronoamperometry, 2 mL of electrolyte sample was collected. To this, 2 mL of solution containing a mixture of 5% salicylic acid and 5% trisodium citrate in 1 M KOH was added followed by the addition of 1 mL of 0.05 M NaClO and 200 μL of 1% sodium nitroprusside as a coloring agent was added. The solution was placed at room temperature for 2 h to develop stable color, and absorbance was measured at a wavelength of 655 nm using UV-Vis spectroscopy. The quantification of NH₃ formed was done by plotting a calibration curve for different concentrations of NH₄+ (0.1, 0.2, 0.4, 0.8, and 1 ppm) using standard NH₄Cl solution, exhibiting a linear relationship between absorbance and concentration value from the fitting curve (y=0.285 x+0.109, R2=0.99581).

Nessler's reagent method. To validate the F.E. and yield obtained using Indophenol blue method, Nessler's reagent test was carried out at −0.15 V vs. RHE. Nessler's reagent was prepared by adding 2.5 g of HgI₂ into aq. solution of KI (2 g in 5 mL deionized water) followed by dilution with DI water up to 20 mL. Finally, 4 g of NaOH was added to the above solution. 5 mL of electrolyte solution collected after chronoamperometry for 2 h at −0.15 V was taken and 0.25 mL of C₄HO₆KNa·4H₂O (500 g L⁻¹) and 0.25 mL of Nessler's reagent was added to it. The above solution mixture was kept undisturbed for 10 minutes and the absorbance was measured at 2=420 nm using UV-Vis spectrophotometer. Similarly for quantification, the calibration curve using the standard NH₄Cl solution with known NH₄+ concentrations (0.1, 0.2, 0.4, 0.8, and 1 ppm) and the linear absorbance vs. concentration was plotted identically.

¹H-Nuclear magnetic resonance (NMR) spectroscopy. The produced ammonia was further confirmed and quantified by using nuclear magnetic resonance (¹H-NMR) measurements with the water suppression method. A single pulse sequence was applied during the relaxation delay of 1 s with a total number of 8000 transient scans and an acquisition time of 2.18 s. Out of the concentrated electrolyte sample, 0.7 ml of the electrolyte was taken and 0.2 ml of DMSO-de was added as an internal standard to achieve sufficient lock signal, and 0.125 mL of maleic acid was added for quantification purposes. Calibration curves were extracted for different concentrations of standard 1+NH₄⁺ solutions with reference to maleic acid as a standard with a total number of 1024 transient scans.

Liquid chromatography-mass spectroscopy (LC-MS). The LC-MS technique was also utilized for NH₃ yield estimation by following the reported procedure.¹ Firstly, 150 μL of phenol solution was mixed with 30 μL of sodium hypochlorite and 30 μL of sodium nitroprusside, and the above solution mixture was then added into 1.5 mL of the NH₄⁺ containing electrolytic (0.1 M H₂SO₄) solution to form Indophenol red complex which was extracted in the organic layer of ethyl acetate (1.5 mL). The organic layer was then completely evaporated, and the powder indophenol red was re-dissolved in methanol for LC-MS quantification. The standard calibration curve was plotted with commercial Indophenol red dye by dissolving it into a methanol solution.

Hydrazine quantification: Nitrogen reduction can also form hydrazine as a by-product and therefore, to verify and quantify if any was produced during NRR was done using the Watt-Chrisp method. At first, 0.3 g of p-CoHnNO was mixed with 2 mL of HCl and 20 mL of ethanol to obtain the final coloring solution. A calibration curve was formed by preparing a series of standard solutions of N₂H₄ (0.1, 0.2, 0.4, 0.8, and 1 ppm). 2 mL of the standard solution was mixed with 2 mL of the coloring solution. Then, the solution was kept for 20 mins at room temperature to achieve stable color, and absorbance at 455 nm was measured using UV-Vis spectrometer. The calibration curve showed a linear relationship between absorbance and different N₂H₄ concentrations. The electrolyte solutions were similarly treated with the coloring solution and hydrazine quantification was done using the calibration curve.

Determination of Nitrate (NO₃) and Nitrite (NO₂): Nitrate (NO₃) determination in 0.1 M H₂SO₄ was determined using UV-Vis spectrometry and an absorbance at 220 nm shows the presence of nitrates. The amount of nitrates was quantified using standard concentrations (0.5 to 5 ppm) prepared using stock NaNO₃ solution. To 5 mL of standard solution and sample electrolyte solution, 0.1 mL of 1 M HCl was added with frequent shaking and then allowed to stand undisturbed for 5 min before the UV-Vis measurement.

For nitrite (NO₂⁻) determination, a diazotization reaction was carried out using sulphanilamide in acid and then coupling it with N-(1-Napthyl)ethylenediamine dihydrochloride, resulting in an azo dye (pink color) giving an absorbance at 540 nm. Similarly, standard concentrations (4 to 60 μg L⁻¹) were prepared from stock NaNO₂ solution. Firstly, solution A was prepared by adding 0.5 g of sulphanilamide in 50 mL of 2M HCl and solution B was prepared using 20 mg of N-(1-Napthyl)ethylenediamine dihydrochloride in 20 mL of deionized H₂O. To a 5 mL solution of the standard solutions and the electrolyte 0.1 mL of solution A was added and kept for 10 mins. Afterward, 0.1 mL of a solution B was added This was then kept undisturbed for 30 minutes and absorbance of NO₂ was observed in a wavelength range of 440-600 nm.

Calculation of F.E. (%) and NH₃ yield rate: After the quantification of NH₃ using different methods, F.E. during NRR was estimated by dividing the electric charge used to produce NH₃ by total charge passed between the electrodes during electrolysis whereas the amount of NH₃ produced was quantified by indophenol blue method.

$$F . E . ( \% ) = \frac{3 \times F \times V \times {C}_{N H 3}}{17 \times Q}$$

NH₃ yield rate was calculated using:

$$Yield rate ( {μgmg}^{- 1} {h}_{ca1 .}^{- 1} ) = \frac{V \times {C}_{N H 3}}{t \times {m}_{cat .}}$$

where F is the Faraday constant, C_{NH3} is the amount of NH₃, Vis the volume of electrolyte taken during electrolysis, t is the time for electrolysis, and m_{cat}. is the catalyst loading on the WE.

Isotope labelling experiments: True source of produced NH₃ during NRR by Ru-Tta-Dfp was confirmed via isotope labelling experiment which was performed by using ¹⁵N₂ (Sigma-Aldrich 99 atom % ¹⁵N) as the feeding gas. The ¹⁵N₂ gas was passed through a home-made purification setup of KMnO₄ and H₂SO₄ before purging into the cell and a fixed amount of gas (200 mL) was supplied during the electrolysis at −0.15 V vs. RHE for 2 h. The produced ammonia in ¹⁵N₂ environments was confirmed and quantified by ¹H NMR with water suppression method. Calibration curves were extracted for different concentrations of standard ¹⁵NH₄⁺ solutions with reference to maleic acid as a standard with a total number of 1024 transient scans. Further, the liquid chromatography-mass spectroscopy (LC-MS) technique was also utilized as a support for NH₃ yield estimation after isotope labelling experiments by following the above mentioned procedure.

Quantification of NON/NH₄⁺ in feeding gas-supplies: The NOx (NO/NO₂) was trapped in alkaline KMnO₄ solution while NH₄⁺ impurities were captured by acid trap before purging in the electrolyte and were quantified using UV-Vis spectrophotometry. The trace N₂O was detected and quantified with the help of GC-MS in SIM (selected ion monitoring) mode by selecting the m/z value of 44 corresponding to N₂₀. The column oven temperature of 40° C. and an injection temperature of 150° C. with the column flow of 0.99 mL min-1, an ion source temperature and interface temperature of 200° C. and 220° C. respectively, were set. The obtained chromatograms were used to draw a calibration curve and calculate the amount of N₂O present in feeding gas supplies used in the study before and after purification. Further, the gas supplies were again tested for NOx and NH₄⁺ impurities after purification and quantified similarly.

### Computational Details

### First-Principles Calculations:

The Vienna ab-initio Simulation Package (VASP) within the framework of plane-wave density functional theory (DFT) was used to investigate the adsorption mechanism of proton and N₂ on the Tta-Dfp. The generalized gradient approximation of the Perdew-Burke-Ernzerhof method is employed for the exchange-correlation functional. Structural relaxation and self-consistent calculations were performed with a Γ-centered k-grid of 5×5×1. The force and energy convergence criteria were set to 0.02 eV/Å and 10-7 eV/atom, respectively. A vacuum space of 15 Å perpendicular to the Tta-Dfp slab is added to avoid artificial interactions due to periodic boundary conditions. The cut-off energy for plane-wave expansions was tested at various values from 400 eV to 550 eV, and it found that total energy is lowest at 520 eV. The adsorption energy of a proton/N₂/Ru with the surface was calculated as follows:

$${E}_{a d s} = {E}_{total} - {E}_{Tta - Dfp} - {E}_{proton / N 2 / Ru}$$

where Eₜₒₜₐₗ, E_{Tta-Dfp-slab}, and E_{proton/N2/Ru} were the total ground state energy of the whole system, the Tta-Dfp slab only, and the energy of the isolated chemical species in a vacuum, respectively.

Molecular dynamics simulation: The diffusion of proton and N₂ molecules through the Tta-Dfp layers was investigated in a simulation box of 9.7×11×9.8 nm³ using the classical molecular dynamics (MD) simulations employed in the LAMMPS package. Two Tta-Dfp membranes, each consisting of three layers, were arranged vertically to split the simulation domain into three regions. There was a central region where proton and N₂ molecules would diffuse. The top and bottom regions contain 25 protons and 25 N₂ molecules, a supersaturated state of nitrogen. The 0.1M HCl was used as the proton source (50 protons), and 50 Cl⁻ ions were added to the simulation box. The system was solvated by adding 34,000 water molecules and first undertaking an initial minimization using the conjugate gradient method at an energy tolerance of 10-7 KJ/mol, followed by a short equilibration at 298 K and 1 atm for 20 ps to remove any residual forces. The system was then kept at the same temperature and pressure for a duration of 10 ns at a timestep of 1fs. The temperature and pressure were controlled using the Nose-Hoover thermostat and Berendsen barostat, respectively. The atomic interactions of the Tta-Dfp were described using the dreiding force-field parameters, the parameters for proton and Cl⁻ were taken from A. Botti, F. Bruni, M. A. Ricci, and A. K. Soper, J. Chem. Phys. 2006, 125, 014508. The water molecule was parametrized using the rigid extended simple point charge (SPC/E) model. The N₂ molecules parameterized for transport properties within the temperature range were taken from the MolMod database. The long-range electrostatic interactions were calculated using the particle-particle particle-mesh solver. The Lorentz-Berthelot arithmetic mixing was employed to consider the pair interaction parameters between different atoms. The truncation radius for the Lennard-Jones and Coulomb interactions was 1.2 nm.

The scope of this disclosure should be determined by the appended claims and their legal equivalents. Therefore, it will be appreciated that the scope of the present disclosure fully encompasses other embodiments which may become obvious to those skilled in the art, and that the scope of the present disclosure is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims.

The foregoing description of various preferred embodiments of the disclosure have been presented for purposes of illustration and description. It is not intended to be exhaustive or to limit the disclosure to the precise embodiments, and obviously many modifications and variations are possible in light of the above teaching. The example embodiments, as described above, were chosen and described in order to best explain the principles of the disclosure and its practical application to thereby enable others skilled in the art to best utilize the disclosure in various embodiments and with various modifications as are suited to the particular use contemplated. It is intended that the scope of the disclosure be defined by the claims appended hereto.

### Discussion of Possible Embodiments

The following are non-exclusive descriptions of possible embodiments of the present invention.

According to one aspect, a catalyst for ammonia production includes a Tta-Dfp covalent organic framework (COF) or analog thereof and a metal embedded into the Tta-Dfp COF to form the catalyst. The Tta-Dfp COF is formed from a 4,4′,4″-(1,3,5-Triazine-2,4,6-triyl)trianiline (Tta) monomer or analog thereof and a 2,6-diformylpyridine (Dfp) monomer or analog thereof.

The catalyst of the preceding paragraph can optionally include, additionally and/or alternatively, one or more of the following features, steps, configurations and/or additional components.

In some embodiments, the metal is present as nanoclusters in the catalyst.

In some embodiments, the COF is formed of two-dimensional (2D) layers.

In some embodiments, the nanoclusters are located between the 2D layers and inside pores of the COF.

In some embodiments, a size of the nanoclusters is between about 3 and about 10 Å.

In some embodiments, a d-spacing of the nanoclusters is between about 0.1 and about 0.9 nm.

In some embodiments, the 2D layers are porous, and a pore size of the 2D layers ranges between about 0.5 nm and about 2 nm.

In some embodiments, the metal at least partially delaminates the COF during formation of the catalyst.

In some embodiments, the metal is ruthenium (Ru).

In some embodiments, the metal includes at least one of ruthenium (Ru), nickel (Ni), iron (Fe), cobalt (Co), palladium (Pd), copper (Cu), manganese (Mn), chromium (Cr), molybdenum (Mo) and Tungsten (W).

In some embodiments, a ratio (by weight) of metal to COF in the catalyst is between about 1:4 and about 4:1.

In some embodiments, the ratio is between about 1:1 and about 3:1.

In some embodiments, the ratio is about 3:1.

In some embodiments, a concentration of the metal in the catalyst is between about 1 and about 5 ppm.

According to another aspect, an in-situ proton filter catalyst for ammonia production includes a COF having a triazine and pyridine moiety and a metal embedded into the COF to form the catalyst. The COF includes two dimensional layers and the metal is located between the layers.

The catalyst of the preceding paragraph can optionally include, additionally and/or alternatively, one or more of the following features, steps, configurations and/or additional components.

In some embodiments, the COF is formed from a nucleophilic triazine and a pyridine ligand.

In some embodiments, the nucleophilic triazine is a 4,4′,4″-(1,3,5-Triazine-2,4,6-triyl)trianiline (Tta) monomer.

In some embodiments, the pyridine ligand is a 2,6-diformylpyridine (Dfp) monomer.

In some embodiments, the metal is ruthenium.

In some embodiments, a ratio (by weight) of ruthenium to COF is between about 1:4 to about 4:1.

In some embodiments, the metal includes nickel (Ni), iron (Fe), cobalt (Co), palladium (Pd), copper (Cu), manganese (Mn), chromium (Cr), molybdenum (Mo) and Tungsten (W).

In some embodiments, the metal is present in the catalyst as nanoclusters.

In some embodiments, the two-dimensional layers are porous and the nanoclusters are present in pores of the two-dimensional layers.

In some embodiments, a concentration of the metal in the catalyst is between about 1 and about 5 ppm.

In some embodiments, the catalyst is thermally stable at temperatures up to about 400° C.

In some embodiments, an ammonium production yield rate of the catalyst is at least 2.0 mg h⁻¹ mg_{cat}⁻¹.

In some embodiments, a Faradaic efficiency (F.E.) of the catalyst is at least 50%.

According to another aspect, a method of forming a catalyst for ammonia production includes synthesizing or providing a COF having a triazine and pyridine moiety, the COF moiety including a plurality of layers. The method further includes partially delaminating the plurality of layers by combining the COF moiety with a metal in a solution and intercalating the metal between layers of the COF moiety to form the catalyst.

The method of the preceding paragraph can optionally include, additionally and/or alternatively, one or more of the following features, steps, configurations and/or additional components.

In some embodiments, partially delaminating the plurality of layers includes dissolving the metal in methanol to form a mixture, sonicating the mixture, and adding the COF as a powder to the mixture.

In some embodiments, a ratio (by weight) of metal to COF is about 3:1.

In some embodiments, the metal is ruthenium (Ru).

In some embodiments, the metal includes at least one of ruthenium (Ru), nickel (Ni), iron (Fe), cobalt (Co), palladium (Pd), copper (Cu), manganese (Mn), chromium (Cr), molybdenum (Mo) and Tungsten (W).

In some embodiments, the COF is Tta-Dfp formed by a 4,4′,4″-(1,3,5-Triazine-2,4,6-triyl)trianiline (Tta) monomer and a 2,6-diformylpyridine (Dfp) monomer.

In some embodiments, synthesizing the COF comprises a Schiff base condensation of Tta with Dfp linkers.

In some embodiments, a ratio (molar) of Tta to Dfp is about 1:1.5.

In some embodiments, the condensation is performed in a mixture of 1,4-dioxane/mesitylene and with a catalytic amount of 6M acetic acid.

In some embodiments, intercalating the metal between layers of the COF moiety includes forming metal nanoclusters.

In some embodiments, the method further includes assembling metal nanoclusters inside pores of the COF.

In some embodiments, a concentration of metal in the catalyst is between about 1 and about 5 ppm.

According to another aspect, a method of performing in-situ proton filtration and nitrogen conversion includes providing a gas feed composition comprising N₂, and exposing the feed composition to a catalyst comprising a COF embedded with a metal. The COF is formed of a triazine and pyridine moiety. The method further includes inhibiting proton diffusion through the catalyst and converting N₂ to NH₃ using the catalyst. The catalyst is configured for simultaneous in-situ proton filtration and nitrogen conversion.

The method of the preceding paragraph can optionally include, additionally and/or alternatively, one or more of the following features, steps, configurations and/or additional components.

In some embodiments, the COF moiety is Tta-Dfp formed by a 4,4′,4″-(1,3,5-Triazine-2,4,6-triyl)trianiline (Tta) monomer and a 2,6-diformylpyridine (Dfp) monomer.

In some embodiments, the metal is ruthenium.

In some embodiments, a Faradaic efficiency (F.E.) of the catalyst is at least 50%.

In some embodiments, a yield rate of the catalyst is at least 2.0 mg h⁻¹ mg _{cat}⁻¹ at −0.15 V, relative to a reversible hydrogen electrode (RHE).

In some embodiments, the catalyst is stable at temperatures up to about 400° C.

Various examples have been described. These and other examples are within the scope of the following claims.

1. A catalyst for ammonia production comprising:
a Tta-Dfp covalent organic framework (COF) or analog thereof, the Tta-Dfp COF formed from a 4,4′,4″-(1,3,5-Triazine-2,4,6-triyl)trianiline (Tta) monomer or analog thereof and a 2,6-diformylpyridine (Dfp) monomer or analog thereof; and
a metal embedded into the Tta-Dfp COF to form the catalyst.

2. The catalyst of claim 1, wherein the metal is present as nanoclusters in the catalyst.

3. The catalyst of claim 2, wherein the COF is formed of two-dimensional (2D) layers.

4. The catalyst of claim 3, wherein the nanoclusters are located between the 2D layers and inside pores of the COF.

5. The catalyst of claim 4, wherein a size of the nanoclusters is between about 3 and about 10 Å.

6. The catalyst of claim 3, wherein the metal at least partially delaminates the COF during formation of the catalyst.

7. The catalyst of claim 1, wherein the metal is ruthenium (Ru).

8. The catalyst of claim 1, wherein the metal includes at least one of ruthenium (Ru), nickel (Ni), iron (Fe), cobalt (Co), palladium (Pd), copper (Cu), manganese (Mn), chromium (Cr), molybdenum (Mo) and Tungsten (W).

9. The catalyst of claim 1, wherein a ratio (by weight) of metal to COF in the catalyst is between about 1:4 and about 4:1.

10. An in-situ proton filter catalyst for ammonia production comprising:
a COF having a triazine and pyridine moiety; and
a metal embedded into the COF to form the catalyst,
wherein the COF includes two dimensional layers and the metal is located between the layers.

11. The catalyst of claim 10, wherein the COF is formed from a nucleophilic triazine and a pyridine ligand.

12. The catalyst of claim 10, wherein a ratio (by weight) of metal to COF is between about 1:4 to about 4:1.

13. The catalyst of claim 10, wherein the catalyst is thermally stable at temperatures up to about 400° C.

14. The catalyst of claim 10, wherein an ammonium production yield rate of the catalyst is at least 2.0 mg h 1 mg_{cat}⁻¹.

15. The catalyst of claim 10, wherein a Faradaic efficiency (F.E.) of the catalyst is at least 50%.

16. A method of forming a catalyst for ammonia production, the method comprising:
synthesizing or providing a COF having a triazine and pyridine moiety, the COF moiety including a plurality of layers;
partially delaminating the plurality of layers by combining the COF moiety with a metal in a solution; and
intercalating the metal between layers of the COF moiety to form the catalyst.

17. The method of claim 16, wherein partially delaminating the plurality of layers comprises:
dissolving the metal in methanol to form a mixture;
sonicating the mixture; and
adding the COF as a powder to the mixture.

18. The method of claim 16, wherein the COF is Tta-Dfp formed by a 4,4′,4″-(1,3,5-Triazine-2,4,6-triyl)trianiline (Tta) monomer and a 2,6-diformylpyridine (Dfp) monomer.

19. The method of claim 18, wherein synthesizing the COF comprises a Schiff base condensation of Tta with Dfp linkers.

20. The method of claim 16, wherein intercalating the metal between layers of the COF moiety includes forming metal nanoclusters that assemble between layers of the COF, and the method further comprises assembling metal nanoclusters inside pores of the COF.
